(19) United States
(12) Patent Application Publication
(10) Pub. No.: US 2026/0370786 A1
(43) Pub. Date: Nov. 19, 2026

(54) SYSTEM FOR, AND METHOD OF, PROVIDING MULTI-SENSORY OUTPUTS FOR USERS BASED ON USER-INTERACTIONS WITH ONE OR MORE OBJECTS

(71) Applicant: Cinesthesia, LLC, Sandy Springs, GA (US)

(72) Inventor: Evan Schechtman, Sandy Srpings, GA (US)

(21) Appl. No.: 19/207,211

(22) Filed: May 13, 2025

(51) Int. Cl. H04N 9/31; G06T 7/55; H04N 23/90

(52) U.S. Cl. CPC H04N 9/3147; G06T 7/55; H04N 23/90

(57) ABSTRACT

A system and method provides one or more sensory outputs based on interaction with one or more objects positioned on a surface. The system and method include one or more sensors configured to detect depth information of the one or more objects, one or more sensory output devices, and a processing unit configured to detect one or more object interactions comprising placement, movement, and/or deformation of the one or more objects based on the detected depth information, and trigger one or more sensory outputs from the one or more sensory output devices responsive to the detected one or more object interactions.

### FIELD OF THE INVENTION

The present invention is directed to a system for, and method of, providing one or more sensory outputs for one or more users based on one or more interactions with or manipulations of one or more objects by the one or more users, and more particularly, to a system for, and method of, providing multi-sensory outputs for one or more users driven by and/or responsive to a detection of one or more interactions with or manipulations of one or more objects on a surface, or portion thereof, by one or more users.

### BACKGROUND OF THE INVENTION

Since the inception of exhibited pre-recorded or generated entertainment, producers have been trying to recreate the reality of locations and/or events, real and/or imagined, for users (e.g., audience members, participants, etc.) such as communal groups of paying audience members. The overwhelming majority of widely available entertainment typically only activates human vision and hearing. The creation and/or exhibition of deep immersion multi-sensory programming commonly requires a user to temporarily augment themselves with head mounted screens and devices, or the like. In other instances, the creation and/or exhibition multi-sensory programming commonly requires purpose-built exhibition spaces and systems. Additionally, in order to create and/or exhibit of deep immersion multi-sensory programming, producers commonly are required to have deep knowledge across multiple domains of expertise and craft, which has so far restricted the production of such deep immersion entertainment to the exclusive domain of subject matter experts, who commonly practice bespoke methods without universal or industry wide standards. Furthermore, such entertainment systems for communal experiences commonly are passive systems and do not allow for interaction with audience members.

### SUMMARY OF THE INVENTION

Exemplary embodiments of the present invention recognize that prior art communal exhibitions do not make any accommodations for personalization within a group context. Instead, prior art communal exhibitions provide content that is shared by all users within the group, such as displaying a communal scene or movie on a table so that everyone at the table sees the same pre-recorded and static content. For example, some prior art communal exhibitions provide content that is shared by all users within the group by displaying a communal scene or movie on each side of a horizon line across a table, so that everyone on both sides of the table sees the same pre-recorded and static content, with the only difference being that the content is displayed from the perspective of each side of the table. Some prior art communal exhibitions display the same pre-recorded and static content based on pre-determined menu selections and/or predetermined content unrelated to menu selections due to limited capabilities of prior art systems to dynamically interact with users, food items (e.g., edible objects) and dinnerware, dishes and food as its consumed, and throughout the user experience. In prior art systems, if a user deviates from the pre-determined menu selections, then the displayed pre-recorded and static content will not match their selections. In prior art communal exhibitions, producers may instruct members of the group to keep objects (e.g., personal objects) off the table and to refrain from moving any other objects on the table, such as plates or other dinnerware, since any such deviations or movements of objects will cause the pre-recorded and static content to not match the table setting. The present invention recognizes that prior art systems do not detect actions and modify the experience in real-time in response to those actions and/or behaviors of users (e.g., audience members, participants, etc.), and/or the manner in which users interact with one or more objects. The prior art systems do not and cannot make any determination, take into consideration, or account for the actions, behaviors, and/or interactions by users, or for that matter, by one or more individual users within a group. Indeed, the prior art systems have no capability of knowing or being aware of the actions, behaviors, and/or interactions by users and do not contemplate or take into account interactions with objects on the surface such as consumption of edible objects. Moreover, the exemplary embodiments of the present invention recognize that, to truly have audience members suspend belief and engage in an experiential dining experience in a novel and immersive manner, it is desirable to have a plurality of human senses of users activated in a spatially and temporally choreographed manner to best recreate a real world human experience or facilitate a fantastical experience driven by the technology and particular arrangement of technological components as described herein. The human senses can include, for example, one or more of, or all of:
i) Vision (Ophthalmoception);
ii) Hearing (Audioception);
iii) Touch (Tactioception);
iv) Smell (Olfaction); and/or
v) Taste (Gustation).

These aforementioned problems associated with prior art systems are only an exemplary list of the shortcomings of the capabilities of the technology of prior art systems, and others are addressed by the present invention, which provides a system for, and method of, providing one or more sensory outputs (e.g., multi-sensory outputs) and increased immersion for one or more users driven by, responsive to, and/or triggered by one or more interactions with or manipulations of one or more objects by the one or more users. The systems and methods of the exemplary embodiments provide an ability to identify a specific shape and/or form of one or more objects (e.g., edible objects) that are placed on a predetermined surface or portion thereof (e.g., a surface of a table or a portion thereof) coupled with an ability to track a location of one or more of the objects placed on the predetermined surface (e.g., one or more edible objects placed on the table.

For example, the exemplary embodiments can provide a system or platform including, for example, hardware and software devices, subsystems, and other components configured as set forth herein to create a real world sensory (e.g., multi-sensory) theatrical experience for users, wherein a detection of a state and/or context of real world objects (e.g., consumable objects), among other things, is configured to trigger interaction by various components of the system.

The exemplary embodiments can address and solve various shortcomings and problems of prior art exhibition systems and venues by providing a system that can modify the experience (e.g., imagery displayed on foodstuffs and the table setting) in real-time in response to user actions (e.g., as a meal item is consumed, the imagery displayed on the meal item is altered) and can activate one or more senses (e.g., at least one sense, two or more senses, three or more sense, four or more senses, or all 5 senses) of one or more users in a temporally and/or contextually immersive way affected by, in response to, and/or triggered by one or more interactions (e.g., natural interactions) between one or more users and one or more objects on a surface or portion thereof (e.g., consumable objects, such a foodstuff, liquids, etc., placed on a table in front of them, drinkware, dinnerware, utensils, serving platters, etc.). The exemplary system can make determinations, take into consideration, and/or account for the actions, behaviors, and/or interactions by one or more users with one or more objects, such as moving one or more objects, consuming, manipulating, deforming, and/or cutting one or more items of foodstuff, consuming one or more liquid, and/or placing one or more other objects (e.g., personal items) on the table, among other things. In some examples, the exemplary system can make determinations, take into consideration, and/or account for other changes related to one or more objects and/or natural interactions of one or more objects with the environment, such as a change in one or more items of foodstuff owing to temperature, gravity, etc., such as melting ice cream, melting ice cubes in a liquid, collapsing or falling of foodstuff (e.g., a piece of cake falling over or collapsing), or the like, and/or the placement and/or addition of other objects on the table, such as personal items of one or more users, among other things. The exemplary system can enable personalization of content for one or more users (e.g., individual users) within a group context. For example, the exemplary system can provide content (e.g., individualized content) that is triggered by and/or specific to a particular user's interaction with one or more objects. Additionally, the exemplary system can eliminate the need for a horizon line across a table to separate content. The exemplary system can be provided in a compact exhibition apparatus. The exemplary embodiments can provide a simple and easy to use appliance-like operation that requires little or no domain specific knowledge to operate and maintain.

In these ways, the exemplary embodiments can improve and/or increase the quality of the experience of users, while at the same time, simplifying cost and/or operation for an owner/operator of the system due to, among other aspects described herein, the configuration of devices, their arrangement, and the technologically improved outcomes associated therewith.

In some examples, the exemplary system can be categorized in the so-called “eater-tainment” industry. In an example, the system can include a hardware and software platform that is purpose built to be deployed, for example, in a compact “mini-theater” embodiment and vernacular. The system can include, for example, one or more of spatially integrated optical sensors, experiential presentation apparatus, audiovisual device, and/or transduction devices, etc., among other things, configured to interact in a new and unique manner such that the exemplary system can be configured to present a creative, timed program reminiscent of, for example, a play or movie for users/audiences, in which audience members are seated on the stage.

In an exemplary embodiment, the system can include one or more sensors (e.g., one or more optical sensors, and more particularly, a plurality and/or array of optical sensors) configured to identify one or more objects on, or above, a predetermined surface or a predetermined portion of a surface (e.g., a planar, curved, sloped, and/or non-uniform surface, a zone or region of the surface, etc.). For example, the plurality of sensors can be configured to identify objects placed on a mini-theater central table surface, while creating a real time mesh topology based on the real world table environment.

In exemplary embodiments, one or more sensors (e.g., a plurality and/or array of optical sensors) can be configured to track a location of one or more objects on the predetermined surface (e.g., table) or part thereof for the purposes of allowing audience members to behave in a manner commensurate with a meal tradition, such as eating, drinking, and/or interacting with an invited group, among other things. The exemplary embodiments can be configured to track and identify one or more objects to provide a contextually and technically immersive target area, for example, for object identification, mesh topology creation, and a canvas for the presentation of geometrically pre-manipulated content (e.g., visual content).

In examples, one or more agents, controllers, or the like of the software platform can be configured to receive, process, and/or utilize the sensed data to identify, data-base match, and/or track tabled objects anywhere on, or above, the predetermined surface or portion thereof.

In various exemplary embodiments, the system can be configured to detect one or more changes (e.g., pre-programmed changes) in a state, position, size, shape, and/or context, etc., among other things, of one or more objects, for example, based on a comparison of reference geometry for known objects on the table and/or stored data. The detected changes can be configured to be one or more inputs or triggers (e.g., predetermined triggers) utilized by a processing unit to activate and/or trigger one or more creative outputs and/or present one or more relevant outputs (e.g., predetermined outputs) from the system.

The system can provide one or more outputs from an audiovisual rendering system (e.g., having one or more video projectors and/or one or more speakers), haptic system, and/or olfactory system, etc., such that operation of the system can activate, stimulate, and/or influence one or more senses (e.g., one or more of, two or more of, three or more, four or more, or all of vision (ophthalmoception), hearing (audioception), touch (tactioception), smell (olfaction), and/or taste (gustation) of one or more users in a temporally and contextually immersive way affected by, in response to, and/or triggered by one or more interactions (e.g., natural interactions) between one or more users and one or more objects on a surface or a portion thereof (e.g., consumable objects, such a foodstuff, liquids, etc., placed on a table in front of them, drinkware, dinnerware, utensils, serving platters, etc.). For example, the system can utilize one or more scents to activate, stimulate, and/or influence taste (e.g., flavor) of one or more foods.

The exemplary systems can employ a projection mapped and blended approach for projection onto a surface or portion thereof, such as a table or portion thereof. The projection mapping can be utilized to turn the surface of the table into a screen, while also providing the ability to project onto one or more objects on the table, such as dinnerware (e.g., drinkware, plates or other dinnerware, utensils, serving platters, etc.) and/or consumable objects, such as foodstuff, liquid, etc.). The exemplary systems and methods can be configured to provide real-time object positioning, utilize object tracking data to adjust the projected content dynamically, provide adaptive projection, and/or warp content to match the one or more objects in real time, such as matching the 3D shape of one or more objects in real time. The exemplary systems and methods can provide a blended projection system (e.g., a blended top-down table projection system) that reduces, minimizes, or eliminates opaque shadows on the table surface during normal user behavior, provides the ability to project content on one or more objects placed on the table, for example, up to a predetermined distance above the surface of the table or away from the surface of the table, provides the ability to project on crevasses, overhangs, and/or occlusions, and/or provides the ability to provide content on all sides of one or more objects on the table, among other things. The exemplary systems and methods can map the projection onto a planar surface, such as a table, by blending the projections at a fixed height of the surface of the table. The exemplary systems and methods also can map the projection onto one or more non-planar surfaces of one or more objects on the table, such as dinnerware (e.g., drinkware, plates or other dinnerware, utensils, serving platters, etc.) and/or consumable objects, such as foodstuff, liquid, etc.), by blending the projections for one or more heights above the surface of the table, while reducing, minimizing, or eliminating visual aberrations and/or incorrect geometry being displayed. The exemplary systems and methods can maintain multiple blend calculations dynamically for one or more objects (e.g., all objects) on the table. The exemplary systems and methods can contextually and/or temporally trigger, for example, one or more changes in creative visual program projected on and around one or more user's dish or dishes (e.g., for a particular or individual user), one or more relevant audio programs to support one or more visuals, one or more scents (e.g., at one or more predefined x, y, z positions within a given dish and/or time code), and/or one or more haptic sensations (e.g., at one or more predefined x, y, z positions within a given dish and/or time code.

For purposes of this disclosure, the terms “user,” “audience member,” “group member,” and “participant” are used interchangeably.

For purposes of this disclosure, the term “object” is not limited to any particular object or objects and can include, for example, one or more of consumable objects such as foodstuff, liquids, etc., drinkware, dinnerware, utensils, serving trays, platters, pitchers, or the like, napkins, linens, clothes, or the like, and/or containers, dispensers, or the like, among other things. For example, the term “object” can include one or more other objects or things such as one or more candles (e.g., lighted or unlighted), decorations, packages and/or presents, ballons or other inflatables, party favors, and/or documents, papers, greeting cards, or the like, among other things. The term “object” also can include one or more objects or things related to one or more users such as one or more parts of a user's body (e.g., a user's hand, arm, etc.), a user's watch, jewelry, wallet, purse, clothing, accessories, or the like, an infant's toys, pacifier, or the like, among other things. Furthermore, the term “object” can include one or more objects or things related to the real world sensory (e.g., multi-sensory) theatrical experience, such as one or more props, souvenirs, keepsakes, or the like, among other things.

For purposes of this disclosure, 3D depth mapping, also known as depth sensing or 3D mapping, creates a three-dimensional view of a given space or object by measuring the distance between a sensor and various points in the environment and typically involves projecting a light source onto an object and capturing the reflected light with a camera or sensor. The time or pattern of light reflection is then analyzed to calculate the distances to different parts of the scene, creating a depth map, which is a digital representation that indicates how far away each part of the scene is from the point of view of the sensor. Example technology used to generate 3D data can include Time-of-Flight (ToF) technology, stereo vision imaging technology, structured light imaging technology, among others.

Time-of-Flight (ToF) technology calculates the time it takes for light to travel to one or more objects, reflect off the one or more objects, and return to the sensor. The measurement enables a Time-of-Flight (ToF) camera to accurately determine the distance to various objects in a scene. The main components of a ToF camera include a Time-of-Flight (ToF) sensor and a sensor module, which capture and convert the reflected light into data that the camera can process. A ToF camera typically utilizes a light source like a Vertical-Cavity Surface-Emitting Laser (VCSEL) or a Light-Emitting Diode (LED) that emits light in the near-infrared (NIR) spectrum. The ToF sensors/cameras can be, for example, direct ToF sensors that measure a time difference between emitting a short light pulse and detecting a reflection of the light pulse back to the sensor to calculate distance, or indirect ToF sensors that measure a phase shift of continuously modulated light to calculate distance. The time of flight sensor can be, for example, a time of flight camera (e.g., ToF 3D camera) or other suitable ToF sensor or tracing sensor, or other technologies, such as machine vision technology. For purposes of this disclosure, the terms “Time of Flight,” “Time of Flight sensor,” “Time of Flight camera,” and “Time of Flight 3D camera” are used interchangeably and include any sensor, camera, and/or device configured to, or capable of, providing 3D depth mapping by calculating the time it takes for light to travel to an object, reflect off of the object, and return to the sensor, as would be understood by one of ordinary skill in the art within the context of the present invention.

For purposes of this disclosure, a fiducial marker or fiducial is defined as an object, coating, marking, ink, or the like placed in the field of view of an image for use as a point of reference or as a measure. Fiducial markers can include, for example, infrared/full-spectrum fiducial markers visible, for example, to one or more sensors or cameras, under one or more lighting conditions, such as infrared lighting. The fiducial markers can be configured to track rotation and/or position of one or more objects. According to the exemplary embodiments, fiducial markers can include, for example: i) High-contrast patterns with minimum feature size, for example, of 2 mm; ii) Error-correcting codes embedded in marker patterns; iii) Hierarchical marker structures for multi-scale detection; iv) Orientation-independent marker designs; and/or v) visible and invisible ink, or various combinations thereof.

By way of example, and not limitation, a first exemplary embodiment of the invention comprises a system for providing one or more sensory outputs (e.g., multi-sensory outputs) based on interaction with one or more objects positioned on a surface, the system comprising one or more sensors configured to detect depth information of the one or more objects, one or more sensory output devices, and a processing unit comprising one or more processors and one or more non-transitory computer-readable storage mediums storing one or more instructions comprising one or more algorithms that when executed by the one or more processors cause the one or more processors to perform one or more steps, wherein the processing unit configured to detect one or more object interactions comprising placement, movement, or deformation of the one or more objects, or a combination of two or more thereof, based on the detected depth information, and trigger one or more sensory outputs from the one or more sensory output devices responsive to the detected one or more object interactions.

In an example, the one or more sensors comprise one or more optical sensors. In examples, the one or more sensors comprise one or more Time of Flight sensors, RGB cameras (e.g., Red Green Blue Cameras designed to capture visible light, modified RGB cameras enhanced to capture near-infrared (NIR) and RGB visible light, or the like), Radio-Frequency Identification (RFID) transmitters, Ultra-wideband (UWB) transmitters, LIDAR (Light Detection and Ranging) sensors, and/or mmWave (Millimeter-wave Radar) sensors. The one or more sensors can be configured for active depth sensing. In an example, an object of the one or more objects comprises one or more fiduciary markers visible to a sensor of the one or more sensors.

In an example, the one or more Time of Flight sensors includes at least a first Time of Flight sensor and a second Time of Flight sensor configured to capture overlapping fields of view. Each of the first Time of Flight sensor and the second Time of Flight sensor can be arranged at a predetermined downfacing angle to the surface. The first Time of Flight sensor and the second Time of Flight sensor can be configured to capture images at a predetermined time offset from each other. In examples, the one or more sensory output devices can include one or more video projectors, audio devices, olfactory devices, transducers, or LED lighting systems, or a combination of two or more thereof. The video projectors can include at least a first video projector and a second video projector configured to project overlapping fields of projection and/or arranged at a predetermined downfacing angle to the surface.

Another exemplary embodiment is directed to a system for providing one or more sensory outputs based on interaction with one or more objects positioned on a surface, the system comprising detecting means for detecting depth information of the one or more objects, one or more sensory output devices, and processing means for detecting one or more object interactions comprising placement, movement, or deformation of the one or more objects, or a combination of two or more thereof, based on the detected depth information and triggering one or more sensory outputs from the one or more sensory output devices responsive to the detected one or more object interactions.

Another exemplary embodiment is directed to a method of providing one or more sensory outputs based on interaction with one or more objects positioned on a surface, the method comprising detecting, using one or more sensors, depth information of the one or more objects, detecting, using a processing unit comprising one or more processors and one or more non-transitory computer-readable storage mediums storing one or more instructions comprising one or more algorithms that when executed by the one or more processors cause the one or more processors to perform one or more steps, one or more object interactions comprising placement, movement, or deformation of the one or more objects, or a combination of two or more thereof, based on the detected depth information, and triggering, using a processing unit, one or more sensory outputs from one or more sensory output devices responsive to the detected one or more object interactions. Another exemplary embodiment is directed to a system for, and method of, providing one or more sensory outputs for one or more users based on a detection of one or more interactions with or manipulations of one or more objects users.

Another exemplary embodiment is directed to a system for, and method of, exhibition of timed, multi person experiences wherein interaction with or manipulation of real world objects by participants trigger outputs expressed through audiovisual and transduction systems.

Yet another exemplary embodiment is directed to compact communal immersive experience hardware and a software platform where interaction by the system with the users is driven by the consumption of edible objects by the users, and a method of using the same.

Another exemplary embodiment is directed to a turnkey hardware and software platform that creates communal, real world sensory experiences (e.g., multi-sensory experiences) triggered by the consumption of edible objects by users, and a method of using the same.

Yet another exemplary embodiment is directed to a system for, and method of, creating contained multi-person experiences that activate one or more human senses (e.g., all five human senses) based on input related to the consumption of edible objects on a table.

Another exemplary embodiment is directed to a platform that exhibits communal multi-sensory experiences that activate one or more human senses (e.g., all five human senses) based on input related to the consumption of edible objects on a table.

Still another exemplary embodiment is directed to a system for, and method of, exhibition of timed, multi person experiences wherein the consumption of edible objects on a table activate one or more human senses (e.g., all five human senses).

According to the exemplary embodiments, the systems and methods can enable identification and tracking of one or more objects (e.g., one or more consumable objects), along with any associated dishware, glassware, or the like, from one position to another position around the table, thereby allowing users to act in a manner that is conducive to normal meal traditions and behaviors.

The systems and methods can identify one or more objects (e.g., one or more consumable objects, dishware, glassware, or the like) placed on the table, for example, based on a comparison of the captured data with a data base of one or more expected objects using, for example, a computer vision system configured to match a predetermined experience (e.g., correct experience) to an object (e.g., to the correct dish), thereby simplifying or improving the ease of operation by a local operator of the platform and minimizing or reducing interaction required on the part of the local operator of the platform.

Another exemplary embodiment is directed to a method of providing one or more sensory outputs based on one or more interactions with one or more objects positioned on a surface. The method can include a first sub-sequence comprising generating, using one or more sensors, depth information including a 3D point cloud of the one or more objects and detecting one or more object interactions comprising placement, movement, or deformation of the one or more objects, or a combination of two or more thereof, based on the detected depth information. The method can include a second sub-sequence comprising segmenting, using a processing unit, the 3D point cloud into one or more segmented objects, matching the one or more segmented objects against a database of predetermined reference objects, deriving a percent of confidence in the matching, and if the percent of confidence is equal to or greater than a predetermined threshold, then selecting a first predetermined content to display on the one or more segmented objects, and displaying, using one or more sensory output devices, the first predetermined content on the one or more segmented objects. The method can include a third sub-sequence comprising determining, using a processing unit, if the one or more object interactions is equal to or greater than a predetermined threshold, and if the one or more object interactions is equal to or greater than the predetermined threshold, then selecting a second predetermined content to display on the one or more segmented objects, and displaying, using one or more sensory output devices, the second predetermined content on the one or more segmented objects.

As an illustrative example, in operation, the exemplary method can include a sub-sequence in which a 3D point cloud is generated and then is segmented into one or more segmented objects, such as one or more scoops of ice cream on a plate. The sub-sequence can match the segmented object (i.e., the ice cream) against a database of predetermined reference objects (e.g., ice cream) and derive a percent of confidence in the match. If the percent of confidence is equal to or greater than a predetermined threshold, then the sub-sequence can select a first predetermined content to display on the segmented object, such as a volcano, and then display, using one or more sensory output devices such as one or more projectors, the predetermined content of a volcano on the segmented object (i.e., the ice cream). If a user interacts with the object (e.g., the ice cream), for example, by eating the ice cream, and/or if the ice cream begins melting, another sub-sequence can determine if the object interaction is equal to or greater than a predetermined threshold, such as a predetermined threshold of a change in size, height, shape, proportion, position, and/or location, among other things. If the object interaction is equal to or greater than the predetermined threshold, then the sub-sequence can select another (e.g., different) predetermined content to display on the segmented object (i.e., the ice cream), such as content of an erupting volcano, for example, with lava flowing, or in a more particular example, with lava flowing from a portion of the segmented object corresponding to an interaction with the object. The sub-sequence then can display, using one or more sensory output devices, such as one or more projectors, the predetermined content of an erupting volcano, lava flow, etc. on the segmented object. The exemplary methods are not limited to displaying predetermined content on the segmented objects. For example, in the example described above, the predetermined content for the segmented object also can include additional predetermined content to display on one or more other objects and/or one or more surfaces in association with the predetermined content, such as displaying lava flowing onto the plate upon which the object (i.e., ice cream) is positioned.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a schematic diagram showing a system according to an exemplary embodiment of the invention;

FIG. 2 is another schematic diagram showing a system according to an exemplary embodiment of the invention;

FIG. 3 is a schematic diagram showing operation of a system according to an exemplary embodiment of the invention;

FIG. 4 is another schematic diagram showing operation of a system according to an exemplary embodiment of the invention;

FIG. 5 is another schematic diagram showing operation of a system according to an exemplary embodiment of the invention;

FIG. 6 is a partial plan view showing a partial field of view of a surface having a plurality of objects as viewed by a system according to an exemplary embodiment of the invention;

FIG. 7 is another partial plan view showing a partial field of view of a surface having a plurality of objects as viewed by a system according to an exemplary embodiment of the invention;

FIG. 8 is a perspective view of a system according to an exemplary embodiment of the invention;

FIG. 9 is a perspective view of a system according to an exemplary embodiment of the invention;

FIG. 10 is a block diagram of a system according to an exemplary embodiment of the invention;

FIG. 11 is a block diagram of a system according to an exemplary embodiment of the invention;

FIG. 12A and FIG. 12B illustrate an example of an olfactory device of a system according to an exemplary embodiment of the invention;

FIG. 13 is a schematic diagram showing a system according to another exemplary embodiment of the invention;

FIG. 14 is a schematic diagram showing a system according to another exemplary embodiment of the invention;

FIG. 15 is another schematic diagram showing a system according to an exemplary embodiment of the invention;

FIG. 16 is a plan view showing a system according to an exemplary embodiment of the invention;

FIG. 17 is a plan view showing a system according to an exemplary embodiment of the invention;

FIG. 18 is a plan view showing a system according to an exemplary embodiment of the invention;

FIG. 19 is a plan view showing a system according to an exemplary embodiment of the invention;

FIG. 20 is a plan view showing a system according to an exemplary embodiment of the invention; and

FIG. 21 is a plan view showing a system according to an exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

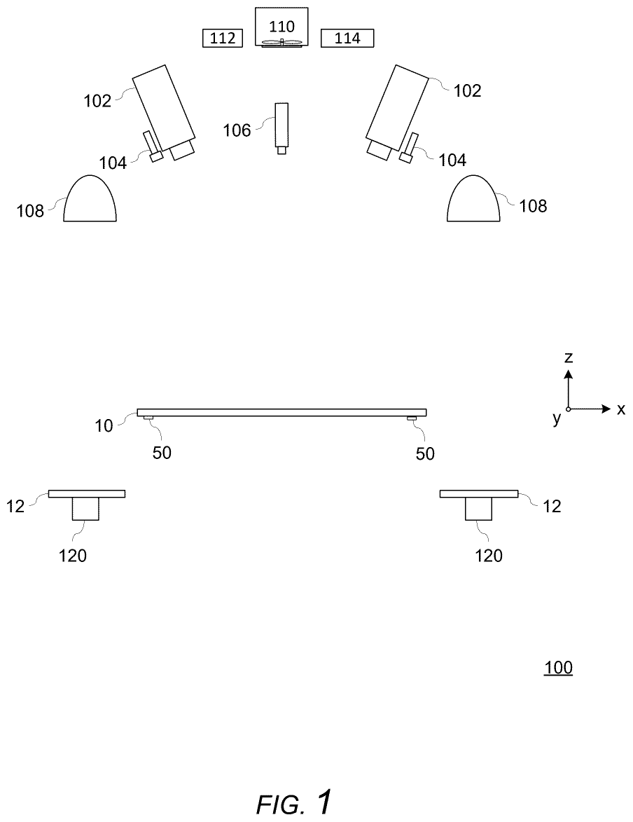

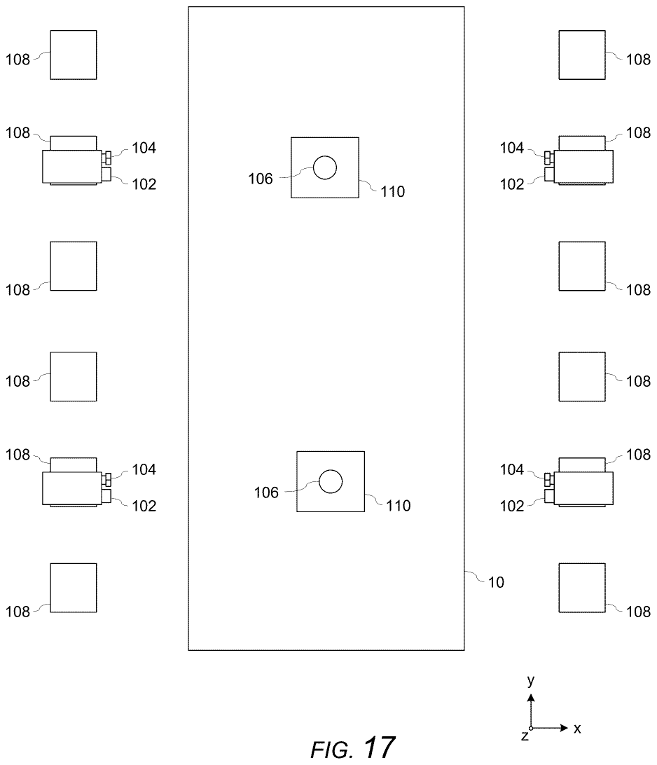

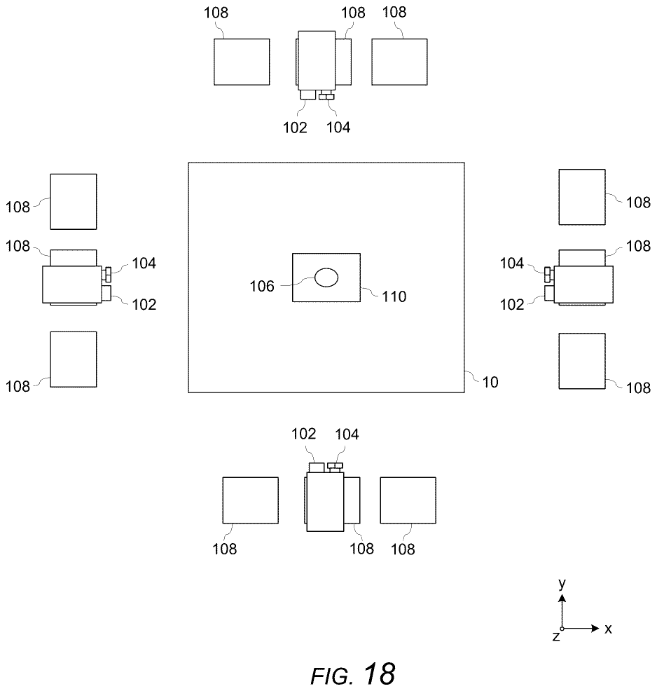

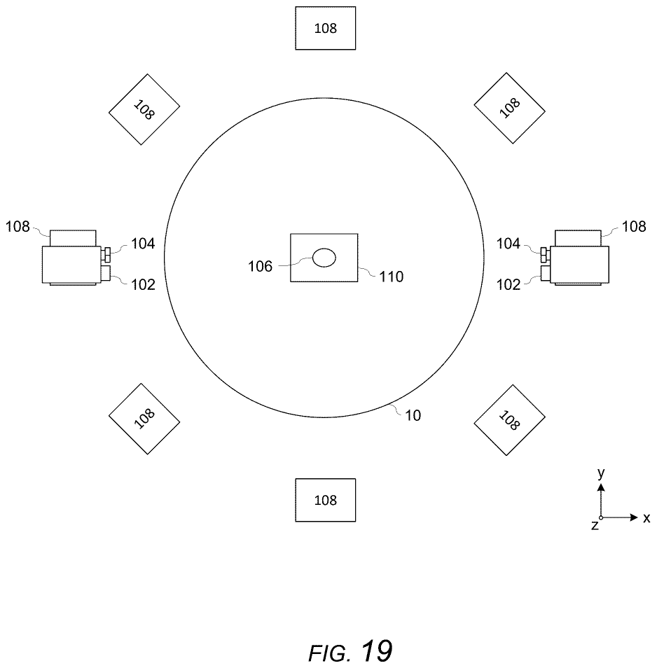

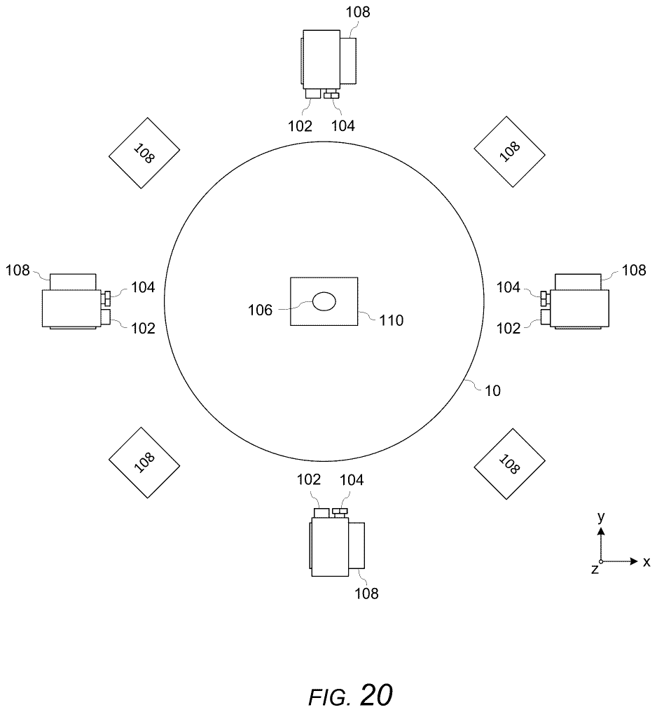

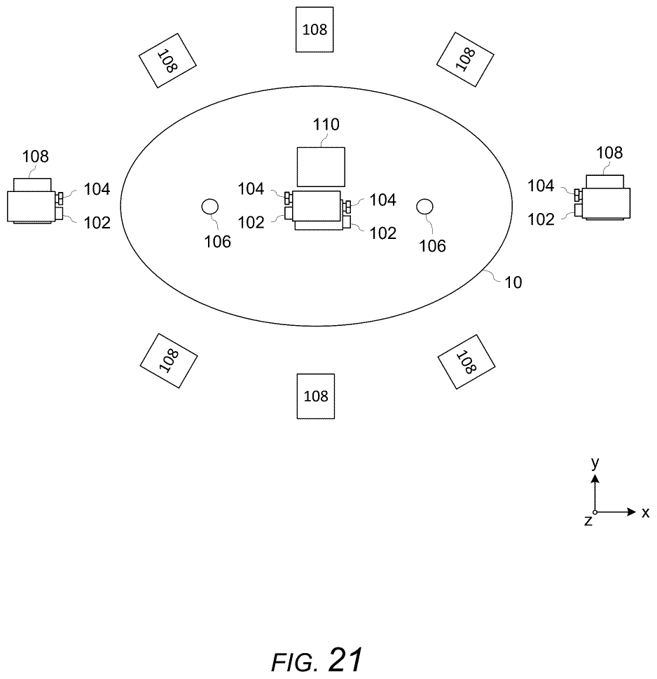

Referring now to the drawings, FIGS. 1-21 illustrate exemplary embodiments of a system for, and method of, providing one or more sensory outputs for one or more users based on one or more interactions with or manipulations of one or more objects on a surface or portion thereof by the one or more users, and sub-sequences thereof.

With reference first to FIG. 1, an exemplary system 100 can include a plurality of video projectors 102, a plurality of sensors, and more particularly optical sensors, such as one or more Time of Flight (ToF) sensors or cameras 104, one or more RGB cameras 106, and/or one or more other suitable image sensors, and one or more audio devices, such as speakers 108. The video projectors 102, optical sensors 104, and RGB camera 106 can be disposed above a surface of a substrate 10, such as a surface of a table or another surface. The speakers 108 can be disposed above a surface of one or more other substrates, such as one or more seating surfaces 12. The exemplary system 100 can include one or more olfactory devices 110, such as a scent generator configured to receive one or more sensory cartridges or pods formulated for a predetermined scent. The exemplary system 100 can include one or more transducers 120 (e.g., haptic transducer, tactile transducer). In the examples, the transducers 120 can be disposed below the one or more seating surfaces 12. The exemplary system 100 can include one or more other components, such as system hardware 112, 114. The exemplary system 100 can include one or more lighting systems such as LED pixel lighting systems, which are schematically illustrated by 50. Various examples and components of the system 100, methods, and/or sub-sequences thereof, will be described in greater detail below.

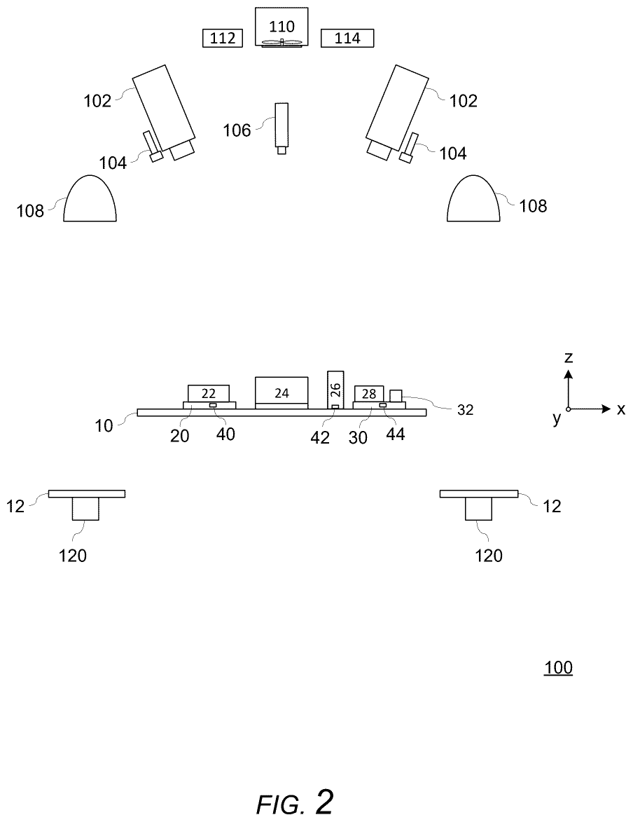

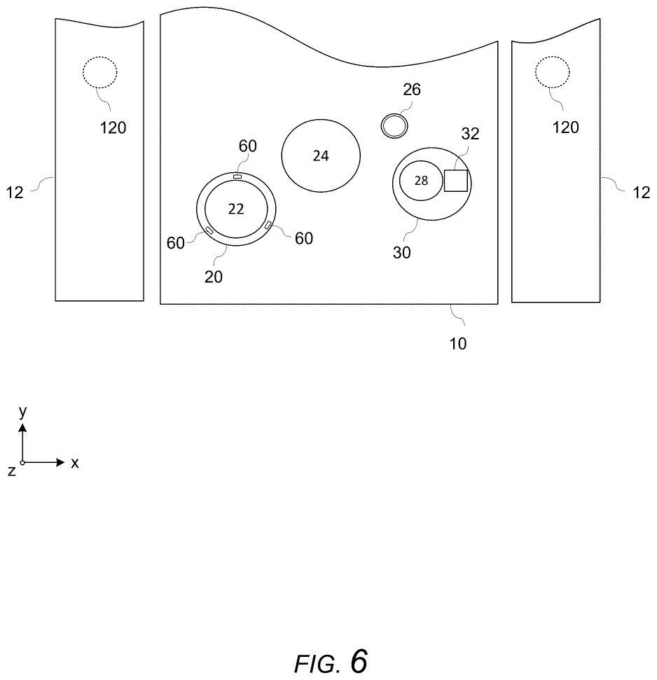

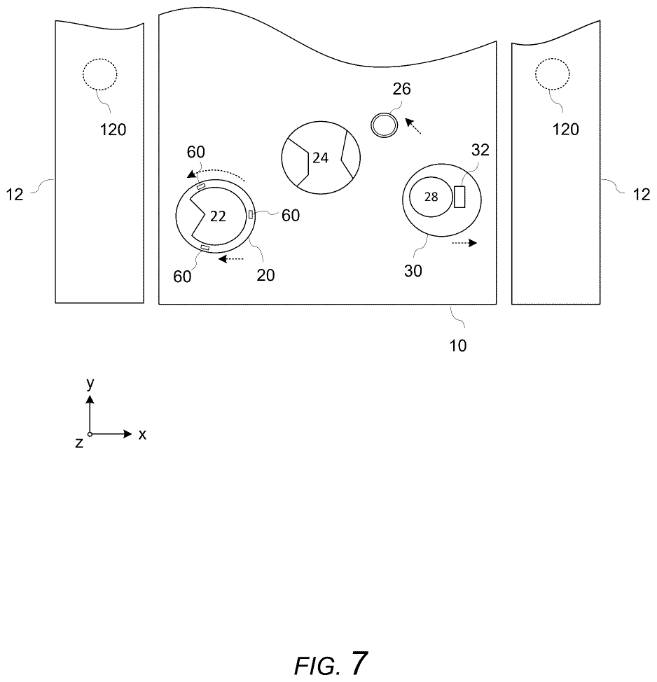

With reference now to FIG. 2, the exemplary system 100 can include one or more objects (e.g., 20, 22, 24, 26, 28, 30, and/or 32) placed on the surface of the substrate 10. In some examples, one or more of the objects can include one or more transmitters 40, 42, 44 (e.g., Radio-Frequency Identification (RFID) tags or Ultra-wideband (UWB) transmitters). In some examples, one or more of the objects can include one or more fiducial marker positions 60 (as shown in FIGS. 6 and 7).

In the illustrative example, the substrate 10 includes a table, the other substrates include seating surfaces 12, and the objects include dinnerware 20, 30, foodstuff 22, 24, 28, 32, and glassware 26.

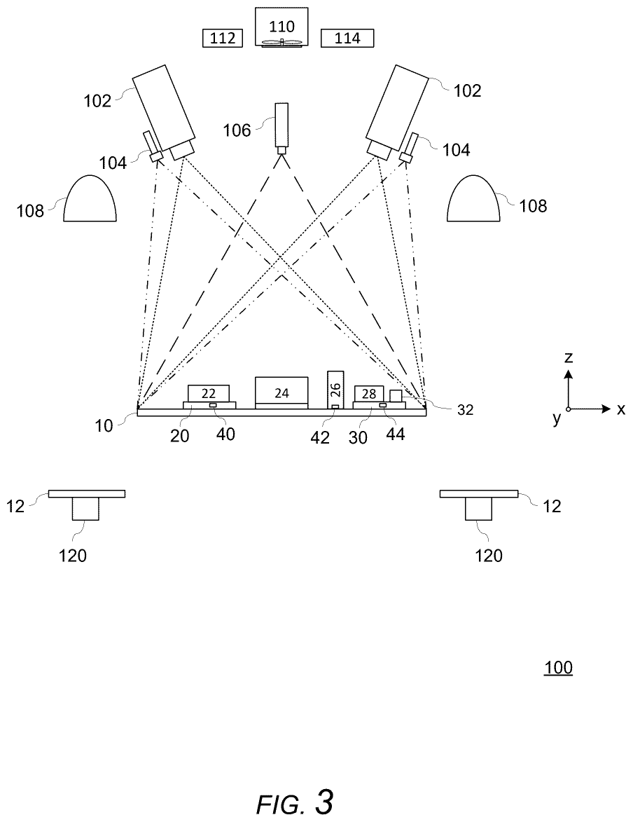

With reference to FIG. 3, each of the ToF cameras 104 can be arranged at a downfacing angle to the surface of the table 10, for example, at about a 50°-75° down facing angle to the surface of the table 10. The downward facing angle is not limited to any particular angle and can include other ranges, such as 30°-85°. In some examples, the downward facing angle can be selected to optimize the field of view of the ToF camera while minimizing and/or avoiding occlusions due to other objects, shadows, and/or users, among other things. In the illustrated examples, two or more ToF cameras can be employed to fill any occlusion zones created by any person or object on the table 10. In this example, the ToF cameras 104 are configured to capture overlapping fields of view and to capture depth information for the objects on the table and to generate a 3D point cloud. Various examples and components of the ToF cameras 104 will be described in greater detail below.

An RGB camera 106 can be disposed (e.g., centrally disposed) above a surface of the table 10 and configured, for example, to provide color and texture information for objects on the table. RFID tags or Ultra-wideband (UWB) transmitters can be embedded in one or more of the objects such as dinnerware 20, 30, and/or glassware 26 and configured to identify the particular objects using a corresponding RFID reader or Ultra-wideband (UWB) reader. An exemplary LED pixel lighting systems 50 can be disposed on one or more surfaces, such as any surface of the system 100. Various examples and components of the system 100, methods, and/or sub-sequences thereof, will be described in greater detail below.

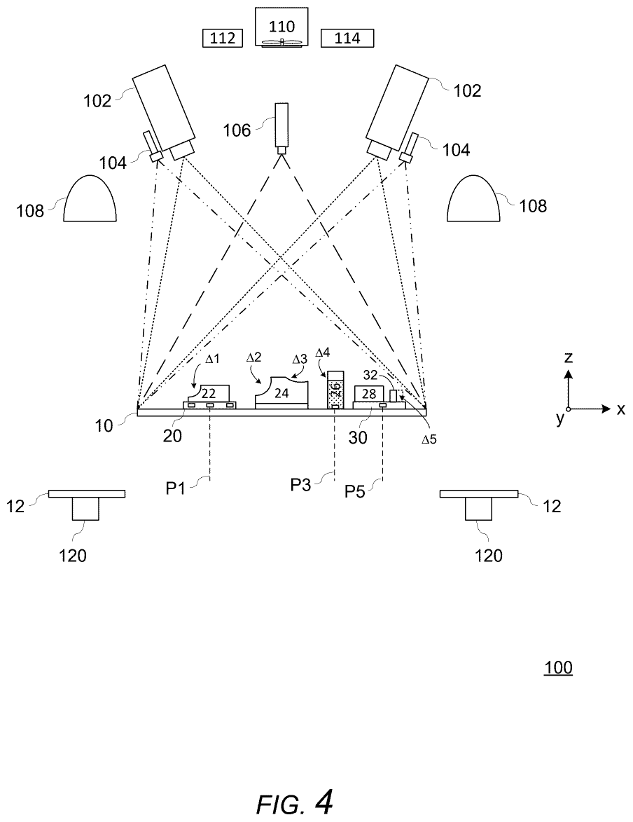

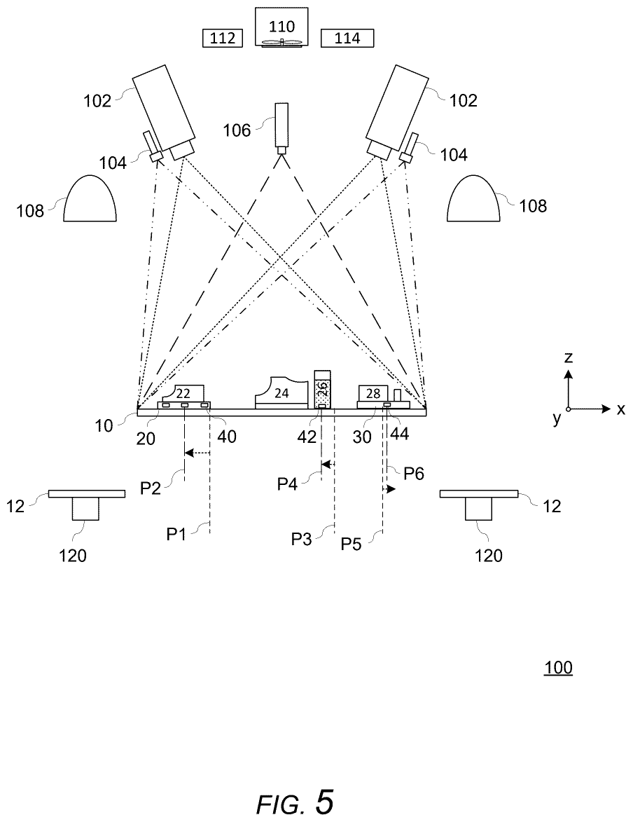

With reference to FIGS. 4 and 5, based on, for example, the captured depth information by the ToF cameras 104, and/or the identification of the objects using one or more RFID tags or Ultra-wideband (UWB) transmitters 40, 42, 44, etc., the system 100 can be configured to detect and/or track one or more changes in one or more of a state of the object on the predetermined surface, a linear position of the object on the predetermined surface, an angular position of the object on the predetermined surface, a height of the object above the predetermined surface, a size of the object, a shape of the object, or context of the object on the predetermined surface, or a combination of two or more thereof (e.g., Δ1, Δ2 Δ3, Δ4, Δ5). For example, FIGS. 4 and 5 illustrate examples of changes (e.g., Δ1, Δ2, Δ3, Δ4, Δ5) in one or more of the objects (e.g., foodstuff 22, 24, 26, and 32), such as a change in a size of the object, a shape of the object, or context of the foodstuff. FIGS. 4 and 5 illustrate examples of other changes in one or more of the objects (e.g., 22, 24, 26, and 32), such as a change in a linear position of the objects on the predetermined surface, such as a change in position of the dinnerware 20, 30 and glassware 26 from position P1 to P2, position P3 to P4, and/or position P5 to P6.

With reference to FIGS. 6 and 7, the ToF cameras 104 are configured to capture overlapping fields of view and to capture depth information for the objects on the table and generate a depth map, and more particularly, a 3D point cloud. The system 100 can be configured to detect and/or track one or more changes in one or more of a state, linear position, size, shape, or context of the object on the predetermined surface (e.g., Δ1, Δ2 Δ3, Δ4, Δ5). For example, FIGS. 4 and 5 illustrate examples of changes (e.g., Δ1, Δ2, Δ3, Δ4, Δ5, and change in position from P1 to P2, position P3 to P4, and/or position P5 to P6) of one or more of the objects (e.g., foodstuff 22, 24, 26, and 32, dinnerware 20, 30, or glassware 26).

FIGS. 6 and 7 illustrate examples of other changes in one or more of the objects (e.g., 20), such as a change in an angular position of the object 20 based on one or more fiducial marker positions 60, which can be configured to allow the system to detect and/or track object rotation and/or position using fiducial markers visible under specific lighting conditions, such as non-visible light (e.g., near infrared (NIR) light).

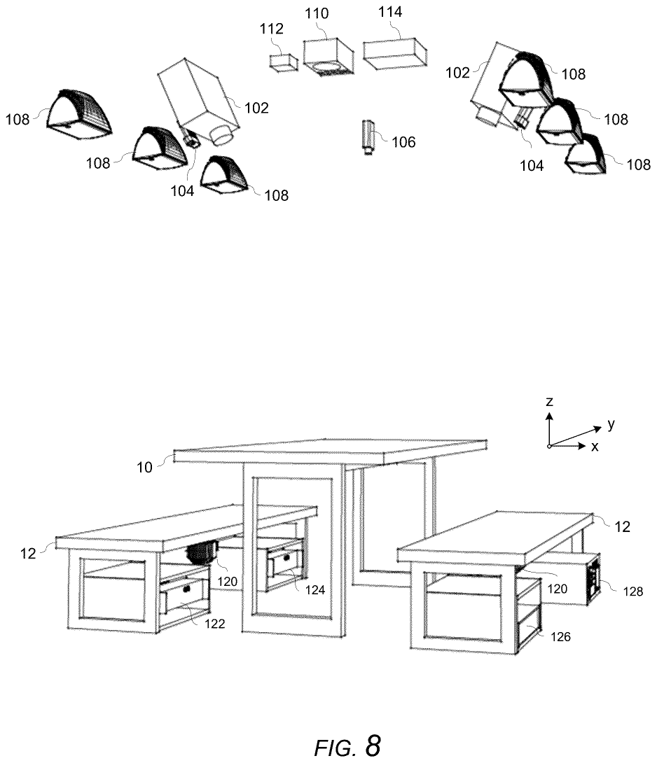

With reference to FIG. 8, an exemplary system 100 can include table 10 and seating surfaces 12. One or more components of the system hardware (e.g., 122, 124, 126, and/or 128) can be disposed below the one or more seating surfaces 12, for example, in one or more predefined spaces or cavities. In some examples, one or more RFID readers can be disposed below the seating surfaces 12.

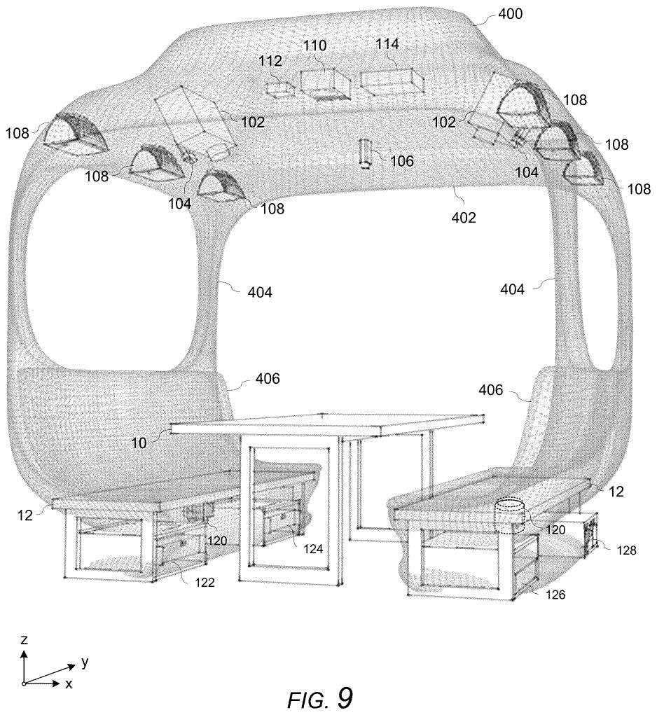

With reference to FIG. 9, an exemplary system 100 can include a housing 400, such as a pod structure, configured to support the components of the exemplary system. The pod structure 400 can include a ceiling or roof 402, one or more walls 404, one or more seating surfaces 406 over the seating surfaces 12, and/or a table 10.

The ceiling or roof 402 of the pod structure 400 can include a space and/or fixation locations for receiving and supporting the plurality of video projectors 102, a plurality of optical sensors, such as Time of Flight (ToF) sensors or cameras 104, one or more RGB cameras 106, and one or more audio devices, such as speakers 108 in predetermined positions above a surface of the table 10 and/or above the one or more seating surfaces 12.

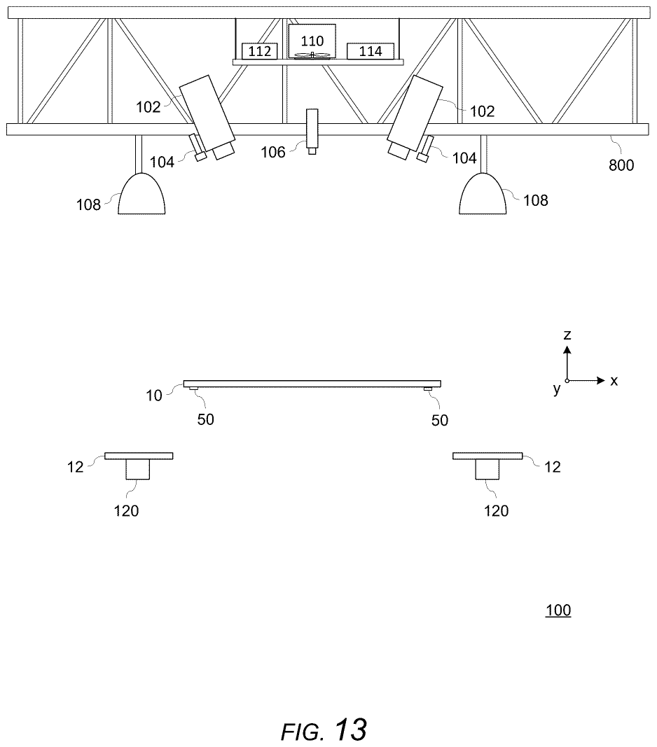

In other examples, an exemplary system 100 can include a rig 800, such as a custom or specialized rig and/or staging structure, as exemplarily illustrated in FIG. 13, configured to support the components of the exemplary system. The rig can include one or more supports such as one or more truss segments, mounts and/or mounting points, bases, and/or stands including a space and/or fixation locations for receiving and supporting the plurality of video projectors 102, a plurality of optical sensors, such as Time of Flight (ToF) sensors or cameras 104, one or more RGB cameras 106, and one or more audio devices, such as speakers 108 in predetermined positions above a surface (e.g., above a surface of the table 10 and/or above one or more seating surfaces 12). In still other examples, an exemplary system 100, such as the pod structure 400, a custom rig, or the like, can be configured with a snap-in arrangement of the one or more components of the exemplary system. For example, one or more of the components can include, or be configured with, a snap-fit mechanism or the like to quickly and easily engage and secure the component to a support structure of the system, such as the pod structure 400, a custom rig, or the like. In examples, the exemplary system 100 can include one or more other support features, such as cable management structures and/or features, hardware support structures and/or features, among other things.

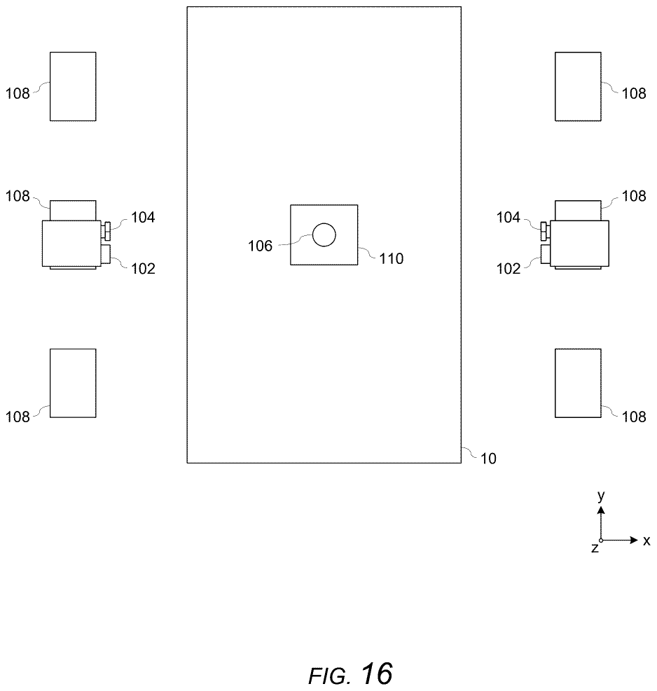

For illustrative purposes, the exemplary embodiments are described with reference to the surface being a table or portion thereof upon which one or more objects are placed and interacted with or manipulated by one or more users. The examples are not limited to any particular type or shape of table and can include, for example, a rectangular, square, circular, or oval table, among other configurations, such as an open-sided shape (e.g., open sided rectangular/square shape, such as a hibachi grill), U-shape, half-circle/oval, among other arrangements, as shown in the exemplary embodiments illustrated in FIGS. 16-21. The examples are not limited to any particular arrangement of the components. For example, with reference again to the exemplary embodiments illustrated in FIGS. 16-21, exemplary systems 100 can include one or more video projectors 102, one or more sensors, such as one or more Time of Flight (ToF) cameras 104, one or more RGB cameras 106, one or more speakers 108, and/or one or more olfactory devices 110 such as a scent generator, among other components arranged in one or more positions suitable for a particular environment and/or table shape, size, configuration, and/or number of users, among other things, for example, to minimize or avoid occlusions, optimize a field of view of one or more sensors, and/or optimize a field of projection/display of one or more projectors, among other things.

The examples are not limited to a table and can include any surface having one or more objects placed thereon and capable of being interacted with or manipulated by one or more users. For example, the surface or portion thereof can include a surface of a wall, floor, bar top, counter top, sidewall, and/or seat, among other things. Various examples of each of the components of the system 100 illustrated in FIGS. 1-7 will be described in greater detail below.

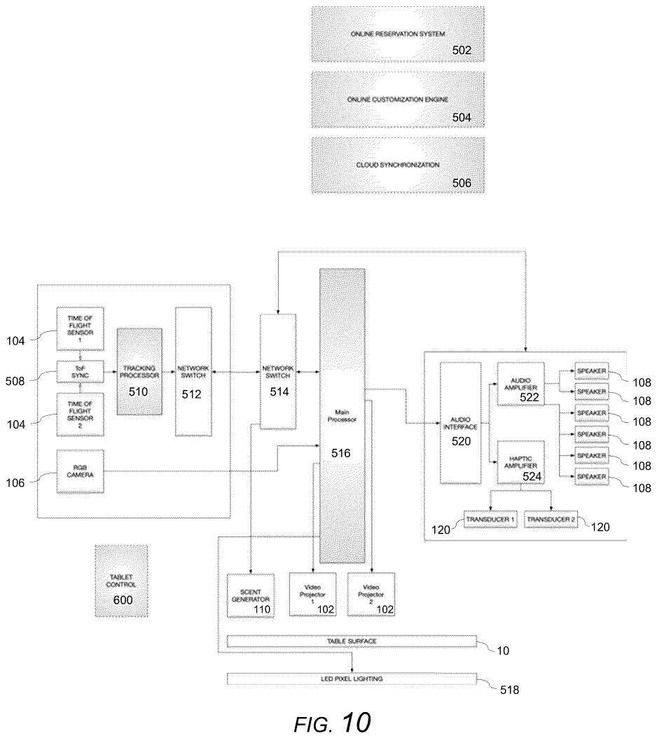

With reference to FIG. 10, an exemplary system 100 includes ToF camera/sensor 1 and ToF camera/sensor 2 (104). The system 100 includes a ToF synchronization module 508 configured to perform data synchronization on the image data captured by ToF camera/sensor 1 and ToF camera/sensor 2 (104). The system 100 includes a tracking processor 510 configured to process the captured data. The tracking processor 516 communicates with a main processor via network switches 512, 514.

In this example, the system 100 also includes an RGB camera 106 configured to provide an input to the main processor 516. One of ordinary skill will recognize that the main processor 516 and/or the tracking processor can include one or more processors and one or more non-transitory computer-readable storage mediums (i.e., memory) storing one or more instructions comprising one or more algorithms that when executed by the one or more processors cause the one or more processors to perform one or more steps.

The system 100 includes a scent generator 110 in communication with the main processor 516 via network switch 514. The scent generator 110 receives instructions from the main processor 516 for controlling operation of the scent generator 110. The system 100 includes video projectors 1, 2 (e.g., 102) in communication with the main processor 516. The video projectors 1, 2 (e.g., 102) receive instructions (e.g., video and/or control communications) from the main processor 516 for controlling operation of the video projectors 1, 2 (e.g., 102). The system 100 includes LED pixel lighting 518 in communication with the main processor 516. The LED pixel lighting 518 receives instructions from the main processor 516 for controlling operation of LED pixel lighting 518.

The system 100 includes an audio interface 520 in communication with the main processor 516. The audio interface 520 receives instructions (e.g., audio and/or control communications) from the main processor 516 for controlling operation of audio amplifier 522 and haptic amplifier 524, which drive the speakers 108 and transducers 1, 2 (e.g., 120). The system 100 can include a tablet control 600 or other suitable control device. The system 100 also can include an online registration system 502, online customization engine 504, and cloud synchronization system 506. Various examples of each of the components of the system 100 illustrated in FIG. 8 will be described in greater detail below.

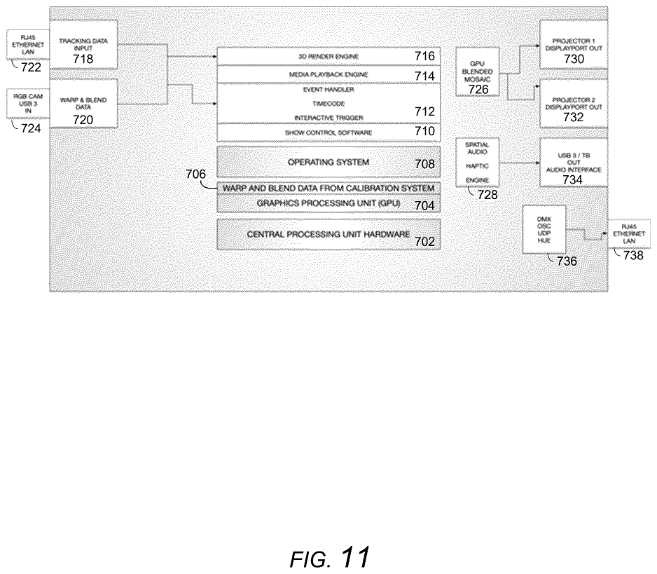

With reference to FIG. 11, an exemplary system 100 includes a main processor 516. The main processor includes, for example, central processing unit hardware 702, a graphics processing unit (GPU) 704, a warp and blend data calibration system 706, an operating system 708, a show control software system 710, event handler, timecode, and interactive trigger module 712, media playback engine 714, and/or a 3D rendering engine 716. The system can include a tracking data input 718 in communication with an RJ45 Ethernet LAN 722 and a warp and blend data input in communication with an RGB Cam USB 3 IN port 722. The system can include a GPU blended mosaic module 726 that outputs data to a projector 1 display port out 730 and a projector 2 display port out 732. The system can include a spatial audio haptic engine that outputs data to a USB 3/TB (Thunderbolt) Out audio interface 734. The system can include a DMX, OSC (Open Sound Control), UDP (User Datagram Protocol), HUE module 736 that outputs to an RJ45 Ethernet LAN 738. Various examples of each of the components of the system 100 illustrated in FIG. 9 will be described in greater detail below.

### Example Tracking System/Sub-Sequence

An exemplary tracking system and exemplary components thereof will now be described with reference again to FIGS. 1-21.

The systems and methods of the exemplary embodiments provide an ability to identify a characteristic of one or more objects (e.g., dinnerware 20, 30, foodstuff 22, 24, 28, 32, glassware 26), such as a specific shape and/or form of one or more objects (e.g., edible or consumable objects), that are placed on a predetermined surface 10 or portion thereof (e.g., a table or portion thereof) in combination with an ability to detect and/or track a location of each of the one or more objects placed on the predetermined surface 10 (e.g., one or more edible objects placed on the table). The exemplary systems and methods can be configured to detect and/or track a location and/or position of one or more objects on the predetermined surface 10 (e.g., a predetermined planar surface such as a table) using one or more sensing modalities. For example, the system can include one or more sensing modalities including one or more of depth cameras (e.g., ToF cameras) 104, one or more fiducial markers 60 and/or one or more sensors or cameras configured to or capable of viewing the fiducial markers 60, infrared tracking, one or more RFID tags and/or readers, and/or one or more Ultra Wide Band (UWB) sensing technologies (e.g., 40, 42, 44), and/or other suitable sensing technologies, or combinations of two or more thereof.

For example, the system can include one or more a ToF (Time-of-Flight) Camera 104, a RGB Camera 106, an RFID System (e.g., 40, 42, 44), a Ultra-wideband (UWB) System (e.g., 40, 42, 44), and/or an Infrared/Full-Spectrum Fiducial Marker 60, or combinations of two or more thereof.

### ToF (Time-of-Flight) Camera:

In an example, one or more ToF cameras can be configured to capture depth information for each point in a scene, and generate a depth map of the scene, and more particularly, a 3D point cloud of the scene (e.g., within the field of view of each ToF camera).

### RGB Camera:

In an example, a RGB camera can be configured to provide color and/or texture information, among other things, for one or more objects on the table.

### RFID System:

In an example, an RFID system can be configured to identify one or more objects on the table based on RFID tags embedded in one or more objects, such as in one or more pieces of dinner ware (e.g., plates, etc.) or other objects.

### Ultra-Wideband (UWB) System:

In an example, an UWB system can be configured to identify one or more objects on the table based on one or more transmitters embedded in one or more objects, such as in one or more pieces of dinner ware (e.g., plates, etc.) or other objects.

### Infrared/Full-Spectrum Fiducial Markers:

In an example, one or more Infrared/Full-Spectrum Fiducial Markers can be configured to detect and/or track rotation and/or position of one or more objects. The one or more markers can be visible, for example, to one or more sensors, under specific lighting conditions.

In examples, the object tracking system can be configured to drive one or more system features including, for example:
i) detecting one or more objects on the table;
ii) tracking one or more objects on the table;
iii) creating a real-time 3D mesh of the geometry of one or more objects on the table;
iv) creating a full spectrum RGB Image of the table and one or more objects on the table;
v) generating a single point cloud of the table and one or more objects on the table that is substantially free from one or more occlusions (e.g., free from major occlusions that may reduce or lower the experience for the user);
vi) measuring the height of one or more objects placed on the table (e.g., height in the z-direction); and/or
vii) identifying a relative rotation of one or more objects on the z axis, and/or
viii) various combinations of two or more thereof.

With reference again to FIGS. 1-21, an example of an Object Depth Subsystem will now be described.

In the exemplary embodiments, an object depth subsystem can include a plurality of sensors, such as a plurality of time of flight (ToF) sensors/cameras 104, or similar technology, such as one or more ToF 3D cameras, or other suitable depth cameras, etc. In an example, the object depth subsystem can include a plurality of ToF sensors/cameras, such as an array comprised of at least two ToF sensors/cameras. In other embodiments, more than two ToF sensors/cameras can be provided. In some examples, four ToF sensors/cameras can be provided. The embodiments of the system are not limited to a particular type of optical sensor/device or depth camera, and can include, for example, any suitable type of depth sensor technology. For example, the one or more sensors can include one or more time of flight (ToF) sensors/cameras, which are capable, for example, of measuring distance by detecting the time it takes for a signal (e.g., infrared light) to travel to an object and back to the sensor. The ToF sensors/cameras can be, for example, direct ToF sensors that measure a time difference between emitting a short light pulse and detecting a reflection of the light pulse back to the sensor to calculate distance, or indirect ToF sensors that measure a phase shift of continuously modulated light to calculate distance. The time of flight sensor can be, for example, a time of flight camera (e.g., ToF 3D camera) or other suitable ToF sensor or tracing sensor, or other technologies, such as machine vision technology. In other examples, the one or more sensors can include one or more LIDAR (Light Detection and Ranging) sensors configured to emit a laser pulse and measure the time it takes for the pulse to reflect back from a person and/or object, for example, using the time-of-flight principle. Various ToF sensors are contemplated and can be configured for a single target (e.g., a single object) or multiple targets (e.g., one or more objects). In other examples, one or more sensors can include a mmWave (Millimeter-wave Radar) sensor configured to detect and measure one or more objects, their movement, etc. In still other examples, one or more sensors can include other suitable technologies including, for example, a Vertical-Cavity Surface-Emitting Laser (VCSEL) sensor or array, VCSEL distance sensors, VCSEL proximity sensors, or other suitable technologies. In still other examples, one or more sensors can utilize SPAD (Single-Photon Avalanche Diode) pixels, arrays, cameras, sensors, or ToF depth sensors configured to measure the distance to an object by detecting the Time of Flight of a signal emitted from a light source until it returns to the image sensor, after being reflected by an object (e.g., a surface of an object, such as a surface of dinnerware, an item of food, liquid, etc. among other things). In some examples, the one or more sensors can include a plurality of sensors, such as a plurality of ToF sensors, positioned in one or more locations, focused on one or more areas or zones of the table, and/or having one or more ranges, predetermined zones of coverage, and/or fields of view. In some examples, the one or more sensors can be positioned in one or more positions to improve or optimize measuring the distance to one or more objects, or parts or surfaces thereof, for a particular area or zone of the table, a particular type or orientation of a particular object, such as a particular type of consumable object, such as foodstuff, liquids, etc., placed on a table in front of a user, drinkware, dinnerware, utensils, serving platters, etc., such as being positioned in one or more positions to improve or optimize detecting and/or tracking a change in one or more particular objects (e.g., consumption of foodstuff, liquids, etc.). For example, the one or more sensors can be positioned in one or more positions to improve or optimize a field of view of the one or more sensors for detecting and/or tracking a change in foodstuff in a bowl or serving container on the table, a change in a liquid in a glass or cup on the table, among other things. In some example, the plurality of sensors can include a plurality of different types of sensors, such as one or more ToF sensors having different characteristics and/or operating parameters.

By way of example, and without limitation, the exemplary embodiments illustrated in FIGS. 1-21 will be described with reference to time of flight (ToF) sensors or cameras.

Each of the time of flight (ToF) sensors or cameras can include an infrared laser grid projector and infrared camera. In some examples, the ToF cameras also can include an RGB camera, for example, in the same enclosure (e.g., in a single enclosure). In some examples, the ToF camera can be configured to operate, for example, at a wavelength in the near-infrared range (e.g., 770 nm-2500 nm), such as 850 nm, 940 nm, or other suitable wavelength ranges. In some examples, the ToF camera can be configured, or scalable, to operate at a predetermined depth range, such as a depth range of, for example, 0.25-5.46 m, or other suitable depth range, for example, depending on the environment. Each of the ToF cameras can be arranged at a downfacing angle to the surface of the table 10, for example, at a 50°-75° down facing angle to the surface of the table 10, or other suitable down facing angle, for example, for minimizing or avoiding occlusions. For example, in other examples, one or more ToF cameras can be arranged to face in a direction perpendicular to the surface (e.g., the surface of a table, the surface of a wall, or other surface, etc.).

In the illustrated examples, two or more ToF cameras can be employed in order to fill any occlusion zones created by any person or object on the table. In an example, the plurality of ToF cameras can be configured to capture overlapping fields of view. In this case, each ToF camera can be configured to capture images using its own associated laser. To prevent interference between lasers of different ToF cameras, the ToF cameras can be configured to capture images at a time offset from each other, such as 160 μs from each other.

According to the exemplary embodiments, the exemplary systems and methods can include a sub-sequence in which the data captured by the ToF cameras can be processed by one or more processors utilizing one or more tracking algorithms. For example, the one or more tracking system algorithms can include, for example:
i) Kalman filtering for motion prediction;
ii) Multiple hypothesis tracking for marker disambiguation;
iii) Temporal consistency checking; and/or
iv) Occlusion prediction and recovery.

In examples, the data captured by the ToF cameras can be processed by one or more processors to perform RGB and Depth Alignment to synchronize RGB images with depth maps from the ToF sensors and calibrate for potential misalignment.

The ToF cameras, or one or more processing units of the ToF cameras and/or a subsystem having the one or more ToF cameras and/or RGB camera, can be configured to (e.g., simultaneously) create raw geometrical meshes of one or more objects (e.g., all objects) on the table. The data from the one or more ToF cameras and/or processing units can be streamed, for example, over a local ethernet network or the like to a main experience processor. The ToF cameras, or one or more processing units of the ToF cameras and/or a subsystem having the one or more ToF cameras and/or RGB camera, can be configured to coalesce and process the captured meshes from the ToF cameras (e.g., all ToF cameras) to create a single point cloud (e.g., single 3D point cloud), which is a real time representation of the real world table and object geometry.

In an example, data from the RGB camera and point cloud (e.g., 3D point cloud) can be merged and calibrated for potential misalignment, for example, by one or more processing units of the RGB camera and/or a subsystem having the RGB camera. In another example, the one or more processing units and/or a subsystem having the one or more ToF cameras and/or RGB camera can employ noise reduction, such as median filtering or bilateral filtering, to clean up ToF noise. In other examples, a main experience processor or the like can be configured to perform one or more of the processes, such as data processing, coalescing, creating, merging, calibrating, noise reduction, and/or filtering.

According to the exemplary embodiments, the system (e.g., the main experience processor of the system) can be configured to perform Data Synchronization. For example, the exemplary systems and methods can include a sub-sequence configured to perform the following data synchronization.

### Temporal Alignment:

In an example, the system can be configured to ensure sensor data (e.g., all sensor data) such as depth, RGB, RFID, and/or fiducial marker positions, are time-synchronized.

### Spatial Registration:

In an example, the system can be configured to calibrate sensors so that RGB images and point clouds are mapped into a common coordinate system.

In some examples, the individual point clouds from each ToF device can be processed by a dedicated CPU/GPU that creates a Point Cloud Processing Pipeline. The processing system can incorporate, for example:
i) Initial depth map acquisition at native resolution;
ii) Point Cloud Fusion to align point clouds from multiple ToF cameras;
iii) ICP (Iterative Closest Point) or Kalman filtering for real-time stabilization;
iv) Depth data filtering using bilateral filters;
v) Point cloud generation with normal estimation;
vi) Background subtraction using adaptive thresholding; and/or
viii) Dynamic voxel grid down sampling.

In operation, the system may require first time calibration, and/or periodic re-calibration, based on one or more changes to the environment or placement of one or more sensors (as shown, for example, in the exemplary environments and sensor placements illustrated in FIGS. 16-21). An exemplary calibration process comprises, for example:
i) Intrinsic parameter calibration using structured light patterns;
ii) Extrinsic calibration using fixed reference objects;
iii) Multi-camera alignment through iterative optimization; and/or
iv) Depth accuracy compensation using polynomial correction.

In an example, in addition to ToF cameras creating a single point cloud, the exemplary systems and methods can be configured to employ a visible and/or an invisible marker based tracking approach, for example, using one or more fiducial markers. In some examples, the visible and/or an invisible marker based tracking approach can be a standalone tracking system and/or it can be combined with other methods of tracking to ensure precise tracking and identification of one or more objects (e.g., one or more unique objects) on the table.

In an example operation, when one or more objects placed on the table is deformed, for example, by the natural consumption by a user, manipulation, separating, and/or cutting by a user, and/or melting, a shape of the one or more objects may no longer be recognizable. The exemplary marker based tracking approach allows the system to continue to identify the one or more objects, while also allowing the system to track a position and/or rotation of each of the one or more objects, or what remains of each of the one or more objects, for example, as the one or more objects are interacted with or manipulated by (e.g., consumed) one or more users. The exemplary system can employ the use of visible, high-contrast markers, as well as markers using infrared ink, that are only visible to infrared cameras, among other suitable markers.

According to the exemplary embodiments, the system can include a fiducial system that utilizes, for example:
i) High-contrast patterns with minimum feature size, for example, of 2 mm;
ii) Error-correcting codes embedded in marker patterns;
iii) Hierarchical marker structures for multi-scale detection;
iv) Orientation-independent marker designs; and/or
v) Visible and invisible ink, or various combinations thereof.

In the exemplary embodiments, the system can include an image processing system for marker tracking, wherein the image processing system is configured to implement, for example:
i) adaptive thresholding with local contrast enhancement;
ii) connected component analysis for marker segmentation;
iii) homography estimation using RANSAC (Random Sample Consensus); and/or
iv) sub-pixel corner detection refinement, or various combinations thereof.

In order to identify one or more objects that are placed on the table, the object tracking system can be configured to create a digital representation of the color and/or shape of a real world object. In an example, the system can be configured (e.g., utilizing local computer vision software) to segment the total point cloud (e.g., 3D point cloud) into one or more distinct objects that can be matched against a database of one or more known reference models. In this way, the exemplary system can be configured to detect, for example, a shape of dinnerware, such as a serving plate or dish, as well as a shape of another object, such as an edible object (e.g., cake, ice cream, one or more fruits, etc.). When comparing captured images and geometry, the system can be configured to allow a predetermined margin of error. A computer vision model can be utilized to derive a percent of confidence in the match, and if confidence meets a predetermined threshold, then the system can be configured to choose the correct content to display onto the object in the real world.

In some examples, an additional method can be employed to increase the fidelity of identification and tracking of one or more objects, for example, in scenarios where the field of view of one or more of the optical sensors are occluded or operating in sub optimal conditions. For example, the system can utilize one or more RFID tags on one or more objects, such as dinnerware and/or glassware (e.g., serving plates and/or glasses). The RFID tags can be configured to interact with one or more receivers, for example, placed under the table surface (e.g., strategically place under the table surface).

In an example, the RFID subsystem can include, for example, an Antenna Array Configuration and a RF Signal Processing system.

In an example, the Antenna Array Configuration can include one or more of:
i) Phased array antenna configuration;
ii) Beam steering capabilities;
iii) Near-field focusing elements; and/or
iv) Interference cancellation systems.

In an example, the RF Signal Processing system can include one or more of:
i) Phase-based positioning algorithms;
ii) Received Signal Strength Indicator (RSSI) fusion from multiple antennas;
iii) Multipath mitigation techniques; and/or
iv) Tag collision resolution protocols.

In some examples, the exemplary systems and methods optionally can utilize one or more (e.g., all) of the tracking methods simultaneously, thereby ensuring a high signal to noise ratio and high confidence rating for identifying and continuing to track one or more objects on the table.

The identification and continued tracking of the one or more objects on the table can be provided as the primary input to the system for driving personal interaction and triggering one or more responses and/or outputs from the system.

In the example system, the varied types of captured data can be processed using Multi-Modal Integration Architecture, including one or more high level mechanisms.

In operation, a Sensor Fusion System can be configured to combine data from the ToF cameras, RGB camera, and fiducial markers to create a synchronized and spatially aligned representation of a scene.

The exemplary system can utilize one or more calibration techniques (e.g., intrinsic and extrinsic calibration) to align the sensors in the same coordinate system.

### Data Fusion Framework/Sub-Sequence

The exemplary system can include an integration system configured to implement, for example:
i) Temporal alignment through synchronized timestamps;
ii) Spatial alignment using common coordinate systems;
iii) Confidence-weighted measurement fusion; and/or
iv) Adaptive modality selection.

### System Control and Monitoring/Sub-sequence

The exemplary system can include a control system including, for example:
i) Real-time performance monitoring;
ii) Automatic calibration verification;
iii) Error detection and recovery; and/or
iv) System health diagnostics.

### Processing Pipeline Implementation

The exemplary system can include processing architecture including, for example:
i) Parallel processing of individual modalities;
ii) Hierarchical fusion of tracking results;
iii) Dynamic resource allocation; and/or
iv) Real-time performance optimization.

### Example Implementations

With reference again to FIGS. 1-21, example implementations of embodiments of the system and method will now be described.

### Implementation A: High-Precision Static Object Tracking

Primary: Depth camera system
Secondary: Fiducial markers
Fusion method: Weighted average with confidence estimation
Accuracy: Sub-millimeter in optimal conditions

### Implementation B: Dynamic Object Tracking

Primary: IR tracking system
Secondary: RFID positioning
Fusion method: Kalman filter with adaptive weighting
Update rate: 100 Hz minimum

### Implementation C: Robust Multi-Object Tracking

i) All modalities active;
ii) Hierarchical fusion architecture;
iii) Automatic modality selection; and/or
iv) Fault-tolerant operation.

### Example Object Detection, Segmentation, Recognition and Matching/Sub-Sequence

According to the exemplary embodiments, the systems and methods, and/or sub-sequences thereof, can utilize an object tracking system for capturing interaction with, or manipulation of, one or more objects on the table by one or more users to drive or trigger, for example, subsequent behaviors and/or interactions (e.g., all subsequent behaviors and interactions). Next, the systems and methods can process the captured depth and RGB data to drive or trigger interaction and to be matched with content (e.g., predetermined content).

The exemplary systems and methods, and/or sub-sequences thereof, can utilize Point Cloud Segmentation to cluster points using DBSCAN (Density-Based Spatial Clustering of Applications with Noise) or RANSAC (Random Sample Consensus) to separate one or more objects from one or more other objects. Next, the systems and methods can apply Edge Detection in RGB, for example using Canny edge detection or GrabCut segmentation, to extract contours of one or more objects. To improve or increase the segmentation as high fidelity, the systems and methods can utilize a Semantic Segmentation, thereby applying one or more neural networks, such as one or more deep learning models such as Mask R-CNN, for more precise segmentation.

Next, the systems and methods can further process the scene for object-recognition and matching to occur. Examples matching processes and steps will now be described.

### Shape-Based Matching (Primitive Shapes)/Sub-Sequence:

i) If an object resembles a simple geometric shape (sphere, cylinder, cube):
   Uses PCA (Principal Component Analysis) to find the best-fitting shape; and
   Compares to known primitives in the database.

This example may be suitable for (e.g., best for) simple foods (e.g., apples, oranges, bread rolls, among other things).

### Advanced 3D Object Matching/Sub-Sequence:

The exemplary systems and methods can provide Feature Extraction, for example, using SIFT, SURF, or ORB for 3D feature matching.

### Descriptor Matching/Sub-Sequence:

The exemplary systems and methods can compare extracted features with database objects using FLANN-based matching and perform Point Cloud Registration.

The exemplary systems and methods can align the detected object with database references using, for example:
i) ICP (Iterative Closest Point) for rigid alignment; and/or
ii) Deep Learning (PointNet/PointNet++) for more robust classification.

### Shape Descriptors/Sub-Sequence:

Uses 3D Zernike Moments or Shape Contexts for shape-based comparison.

### RFID Augmented Identification/Sub-Sequence:

If RFID is present, then the system can be configured to retrieve (e.g., directly retrieve) object metadata.

If RFID data conflicts with visual data, then the system can be configured to prioritize a particular visual data or flag an anomaly.

### Example Projection System/Sub-Sequence

According to exemplary embodiments, an exemplary projection system or platform can employ a projection mapped and blended approach for projection onto a surface or portion thereof, such as a table or portion thereof. This subsystem can be driven (e.g., driven directly) by a video output of a main processor. In this way, projection mapping can be utilized to turn the surface of the table into a screen, while also providing the ability to project onto one or more objects on the table, such as dinnerware (e.g., plates) and/or foodstuff on the table.

The exemplary systems and methods can include a Projection Mapping Subsystem, for example, configured to provide Real-time Object Positioning; utilize object tracking data to adjust the projected content dynamically, provide Adaptive Projection; and/or warp content to match the 3D shape of one or more objects in real time, for example, as a shape of one or more objects is deformed.

In an example, the Projection Mapping Subsystem can include two projectors (for example, of the same make, model, and lens) mounted or fixed above the table. The Projection Mapping Subsystem can be augmented with a RGB camera (e.g., RGB full spectrum camera) that is mounted or fixed above the center of the table facing straight to down. The RGB camera and a selected lens of the RGB camera can ensure the surface of the table (e.g., the entire surface of the table) is in unobstructed view. The relationship between lens and height of the camera can be balanced to create a view of the table that is free from geometric distortion due to wide angle lens distortion, also known as the fish-eye effect. Depending on environmental variables, the RGB camera can have USB connectivity, or may use ethernet for connectivity, or other suitable connectivity.

The exemplary systems and methods can utilize the RGB camera for, for example:
i) The input for the projection blending calibration system to be described;
ii) To provide a real time view of table activities; and/or
iii) For the possible capture and/or sharing of table images.

In an example, the projectors can be mounted at a predetermined downward facing angle with respect to the table, such as a 60°-75° downward facing angle. The downward facing angle is not limited to any particular angle and can include other ranges, such as 30°-85°. In some examples, the downward facing angle can be selected to optimize the field of view of the ToF camera while minimizing and/or avoiding occlusions due to other objects, shadows, and/or users, among other things. In an example, the center of the projection lens can be offset from the table edge by a predetermined distance, such as 6-8 inches. The height of the projectors is not limited to any particular height and can be selected based on one or more environmental factors and/or characteristics of a particular projector, such as resolution, etc., among other things. In some examples, the height of the projectors can range, for example, from 4′7″ to 5′6″ off (i.e., above) the table surface (e.g., above a center of the table surface or a predetermined portion of the table surface). In some other examples, the height of the projectors can be disposed closer or farther from the table surface, for example, from 3′ to 13′, 3′6″ to 12′, 4′ to 10′, among other ranges, above the table surface (e.g., above a center of the table surface or a predetermined portion of the table surface).

In an example, the images from the projectors can be arranged to cover a width of the surface of the table, wherein the width of the table is not particularly limited and the components described herein can be arranged and operated as set forth herein to fit any size and/or shape table or other surface. In an example, the table length can have a predetermined length, such as 72″. The table length can have a predetermined width or range of width, for example, ranging from 36″-48″ depending on one or more environmental factors.

In operation, the images from the projectors can be arranged to overlap on the surface of the table.

The embodiments recognize that raw imagery from the projectors (i.e., without calibration, blending, and warping) may exceed the table size to a large degree, and non-blended imagery from two projectors typically may be incoherent. To solve these and other problems, the Projection Mapping Subsystem can therefore be calibrated using structured light patterns onto the table surface driven by the main processor, one projector at a time. These images can be captured by the dedicated RGB camera for the purpose of understanding which parts of the projected image are visible on the table surface. Additionally, any irregularities of the table surface may be exposed by deformations in the projected geometric patterns, and correspondingly compensated for after calculation. Once the calibration process has been performed on both projectors, the main processor can utilize software running thereon to calculate the total active surface area and corrected topology.

In another step (e.g., a final step), the system and method can continue refinement by exposing a user interface on the table surface that a technician utilizes to adjust the corners of the projected image to fit (e.g., to fit exactly) onto the table surface. Once this adjustment is complete, the system will have been calibrated such that two projectors produce or display a single image. A custom blend and warp map can be created for each projector that makes the two images blend like puzzle pieces. The resolution of the final projected canvas can be calculated based on the number of visible pixels in the canvas, which is not the native resolution of each projector. The accepted “Blended” configuration can then be pushed or hooked directly into a Graphics Processing Unit (GPU), where it sits below the operating system level, and lives semi-permanent memory. This technique can utilize specialized GPUs, for example from Nvidia, and preferably supports the Mosaic standard.

By providing a blended top-down table projection system, the exemplary system and method can provide advantages, which were not achievable using prior art systems, such as:
i) No opaque shadows on the table surface during normal user behavior;
ii) The ability to project content on a maximum surface area of one or more objects placed on the table, for example, up to 12 inches high (e.g., up to a predetermined distance above the surface of the table or away from the surface of the table);
iii) The ability to project on crevasses, overhangs, and/or occlusions;
iv) The ability to provide content on all sides of one or more objects on the table; and/or
v) The ability to establish a level of critical redundancy in the case of single projector failure.

In an example in which the projection is mapped onto a planar surface, such as a table, the projectors can be blended at the fixed z height of the surface of the table. In this example, all projected content can appear as a single image. However, as one or more objects are placed or sit on the table, their independent z heights may break normal projection mapping blends, thereby creating visual aberrations and incorrect geometry to be displayed.

To solve these and other problems, the exemplary systems and methods add an additional layer of calculations for one or more objects on the table that allows the system to maintain multiple blend calculations dynamically for one or more objects (e.g., all objects) on the table.

### Example Object Projection Mapping/Sub-Sequence

### Reference Object Creation for Database

### 1. Capturing Reference Objects

i) Scan with ToF or Structured Light Scanner;
ii) Photogrammetry-based 3D Reconstruction; and/or
ii) Uses multi-view RGB images to generate a high-res 3D model.

### 2. Processing the 3D Model

i) Mesh Simplification;
ii) Reduces polygon count for real-time matching;
iii) Feature Extraction; and/or
iv) Computes 3D shape descriptors for database storage.

### 3. Storing in Database

i) Stores 3D Mesh+Feature Descriptors; and/or
ii) Associates RFID tags (if applicable).

### Example Electro Acoustic System/Sub-Sequence

The acoustic exhibition of the exemplary system can include a spatial audio system made up of a plurality of point source audio devices (e.g., 4 to 6 point source speakers) arranged, for example, in a down firing configuration, such as situated above the seated users. The audio program that plays with each show can be unique and contain both communal scene audio as well as audio that is localized to the action in front of each user.

The mixing of audio programs (communal scenic and personal) can be processed by a main show processor. In an example, the personal audio program can be configured to travel on a zone basis based on detected movement of one or more objects on the table, for example, by a user. In operation, as the object moves, the system can output an associated sound program to be most dominant on one or more speakers that are closest to the object.

The electroacoustic system can be comprised of independent hardware components. In an example, an audio Interface can be connected to a main show processor using USB 3 or Thunderbolt 3 or other suitable or better connectivity. In an example, the audio interface can be configured to act as the Digital Signal Processor (DSP) and Digital to Analog converter (DAC). The audio interface preferably has a minimum of 8 balanced audio outputs. In other examples, the audio interface preferably has a maximum of 16 balanced audio outputs. However, other configurations are possible.

The analog outputs for the overhead speakers can be routed to dedicated amplification channels on a multi-channel Amplifier (Amp) with integrated DSP and Equalizer (EQ). The amplifier can be connected to dedicated point source speakers that operate, for example, at 8 Ohms.

During system deployment, the number of overhead speakers can be predetermined in the system to allow for the correct zoning or panning of audio based on placement of one or more objects. In operation, the placement of one or more objects on the table is detected (e.g., known) by the object tracking systems and drives/triggers the positional audio associated with the story being told in the table object.

### Example Haptic System/Sub-Sequence

In order to drive the touch sensation (Tactioception), the exemplary systems and methods leverage a primary surface that is making continued contact with users, such as a seating surface. For example, a haptic transducer can be coupled to each bench seat, for example, using rubber washers and fasteners. In an example, the transducers can be wired to a dedicated amplifier working at 2 Ohms. A channel of audio can be supplied by the audio system interface. The exemplary embodiments are not limited to a particular surface and can include other surfaces, for example, such as a back surface, armrest, and/or headrest of a seat, a floor surface (e.g., under a user's feet), a counter top, a bar top, a wall, among other surfaces.

To simplify the process of creating touch sensations, the exemplary systems and methods can drive the transducer using techniques developed for theatrical surround sound, levering the Low Frequency Effect or LFE channel traditionally meant for full bandwidth subwoofers. This allows for haptic control using audio techniques. In addition to driving a sense of touch or feeling, subwoofer like effects can be felt and not heard, controlling the comfort of the environment by not filling the space with competing audible subwoofers.

### Example Olfactory System/Sub-Sequence

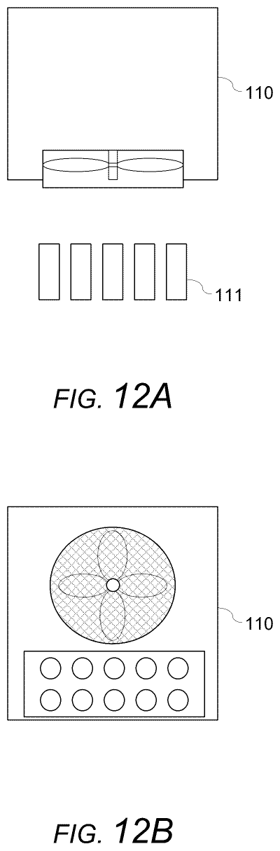

The present invention recognizes that the sense of Smell (Olfaction) is underestimated in the power to transport users. Olfaction is processed in a part of the brain adjacent to memory processing, whereas olfactory recall can chemically transport someone to a place in their mind, and is more reliable than visual recall. With reference to FIGS. 12A and 12B, the exemplary system can include an olfactory system (e.g., a scent generator) 110 comprised of an individually addressable scent dispenser that houses individual scent “cartridges” 111, along with an integrated fan, an external fan, and a manifold. Individual scent cartridges 111 contain the scent fluid in a spray canister. An individual atomizer can be actuated by a servo driven cam. The self-contained nature of each cartridge 111 prevents cross contamination between scent atomizing.

The scent generator 110 can include an integrated RJ45 port, which provides basic networking capabilities. The system can use DHCP to obtain an IP address from the main controller. The scent generator 110 can be configured to listen for UDP messages that contain which scent cartridge to activate, for how long, and/or how long to run the integrated fan. Additional messages can be sent to trigger the external fan, whereas the timing may be dependent on one or more local environmental factors.

The scent generator can be calibrated by taking the average time in seconds between scent atomizing and the scent arriving at the nose of a user. This time offset can be entered into the primary scent controller upon commissioning and final calibration to ensure timed and triggered cues arrive at a user at contextually relevant times.

The exemplary systems and methods can include a show control system configured to send UDP messages to the olfactory system, for example, based on deterministic timecode cues in embedded show media. The exemplary systems and methods also can be triggered to send UDP messages based on interactions by a user with one or more objects on the table.

### Example Show Control/Sub-Sequence

The exemplary systems and methods can include a main processor. The main processor can be a custom form factor specialized computer running a modified operating system, and carefully selected peripheral stack. In an example, a proprietary software can be provided to replace the standard operating system. For example, the system can be configured with proprietary software to replace the Windows shell completely. The main processor can be configured to launch the proprietary software upon startup and power failure, thereby rendering this computer a single purpose processor for all show related Input/Output (I/O), Data Processing, and Rendering. The exemplary system can run a creative program, known as a “Show,” which can be selected from a remote tablet 600 provided to the operator of the experience.

With reference again to FIGS. 1-21, the exemplary systems and methods utilize the data from one or more subsystems as inputs to one or more other systems responsible for cause and effect. For example, the system preferably uses a user's tactile and physical interaction with (e.g., manipulation of) one or more objects, such as one or more edible objects, on the table in front of the user. The analog behavior can be digitized and processed utilizing the object tracking sub system.

In examples, the object level interaction of a user at the table can contextually and/or temporally trigger, for example:
i) one or more changes in creative visual program projected on and around one or more user's dish or dishes (e.g., a particular or individual user);
ii) one or more relevant audio programs to support one or more visuals;
iii) one or more scents at predefined x, y, z positions within a given dish, or time code; and/or
iv) one or more haptic sensations at predefined x, y, z positions within a given dish, or time code.

In addition to the activation of the audiovisual rendering, haptic and olfactory systems based on user interaction, external theatrical and interactive rendering systems can have bi-directional communication with the show controller.

In an example, Theatrical Room Lighting systems can communicate with the show control system using, for example, the DMX (Digital Multiplex) protocol. Theatrical lighting can be driven by preset scenes created in our proprietary system or DMX lighting can be driven by a multi-point color targeting system, choosing from wall or table content.

The system can be configured to utilize custom or private standards, and/or worldwide standards such as DMX. For example, in addition to the worldwide standard of DMX, the exemplary systems can integrate a lighting protocol used by the private world standard for consumer addressable lighting, such as Philips HUE.

The exemplary system also can be configured to use asynchronous Open Sound Control (OSC), for remote control operations and to provide a future path to integrate with external theatrical systems.

User Datagram Protocol (UDP) are simple messages that can be sent to all devices on a network or a single device on the network. These low latency, pre-defined ascii commands are the lowest common denominator for control communications allowing the exemplary system to have allow barrier for basic integration into any existing environment.

In the examples, the open, but controlled Network Device Interface (NDI) can be employed to allow for low latency, high quality external video to be fed into the audiovisual rendering pipeline allowing for the ultimate in flexibility of integration into any existing video system as needed.

Local, external control of the system, such as the system embodied as a mini theater pod, can be controlled by a tablet or other suitable device, for example, configured in a kiosk mode, wherein the tablet only runs a control application for the exemplary system, for example, like an appliance. This exemplary remote control interface can allow a local operator to control one or more (e.g., all) aspects of the system, including for example:
i) Startup;
ii) Calibration;
iii) Service Mode;
iv) Show Mode;
v) Start;
vi) Stop;
vii) Pause;
viii) Special Modes;
ix) Birthday; and/or
x) Live Video.

### Example Subsystem Functions and Elements/Sub-Sequences

With reference again to FIGS. 1-21, the exemplary systems and methods provide object detection, tracking, segmentation, and/or deformation for a tabletop experience system utilizing one or more sensors, such as one or more Time of Flight (ToF) sensors or sensor arrays for real-time 3D mapping and sensory-driven interactions with one or more objects. Table 1 illustrates examples of functional features of one or more subsystems and examples of corresponding elements of the exemplary systems and methods configured for, or capable of, providing one or more functions.

TABLE 1

| | System Elements and/or Features/Sub- |
|---|---|
| Subsystem Function | sequences |
| Depth Sensing/Object Mapping | ToF Cameras and/or RGB Cameras and/or |
| | Optional RFID/UWB |
| Object Identification | Fiducials, RFID tags, and/or depth profiles |
| Object Tracking | ToF depth tracking of object displacement |
| Deformation Detection | Changes in 3D shape via depth mesh |
| | comparison |
| Scent Activation | Triggered by object interaction events |
| Audio and Lighting Sync | Driven by deterministic system responding to |
| | object changes |
| Multi-Object Interaction | Specific tracking and mapping of a plurality |
| | of objects |
| Edible Objects Driving Story Events | Tracking of table items |

The exemplary embodiments are not limited to the examples illustrated in FIGS. 1-21 and can include other components and/or configurations. For example, the systems and methods for providing object detection, tracking, segmentation, and/or deformation on a tabletop experience system can be configured to provide real-time 3D mapping and sensory-driven interactions in other ways, such as without utilizing one or more Time of Flight (ToF) sensors or sensor arrays.

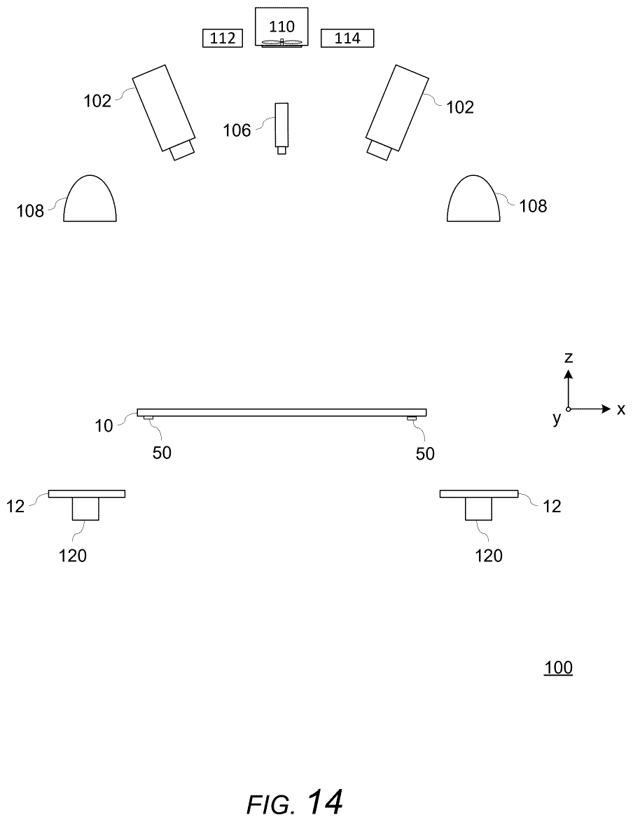

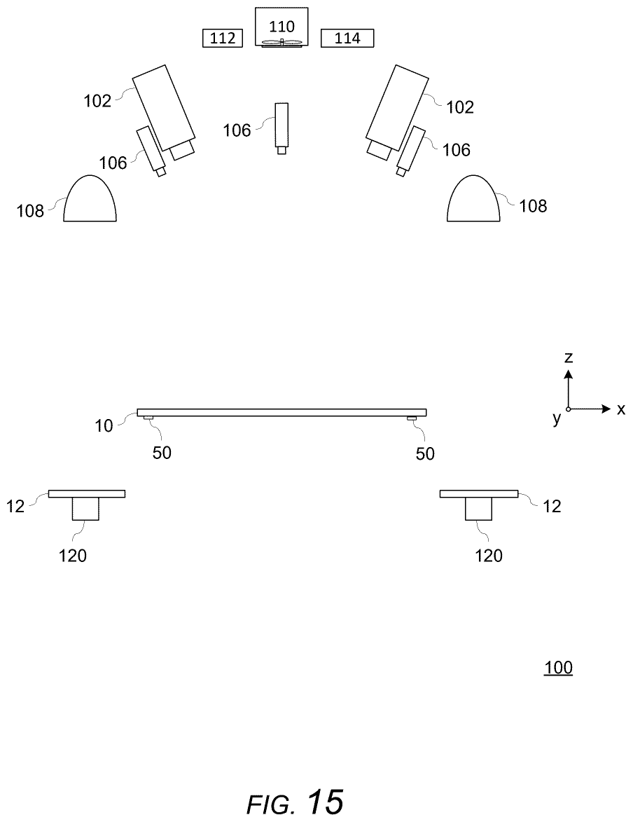

For example, in other exemplary embodiments, as shown in FIGS. 14 and 15, the exemplary systems and methods can utilize RGB-based depth estimation using artificial intelligence (AI). In this example, the system can include one or more RGB cameras 106 (e.g., standard RGB cameras), which can be positioned overhead (e.g., over the surface). The one or more RGB cameras 106 can be fixed or mobile. The system also can include one or more neural networks trained, for example, for monocular (e.g., single-camera) or stereo RGB depth estimation. For example, the system can be configured for, or capable of:
i) inferring depth maps from 2D imagery;
ii) tracking objects and identifying one or more of a size, shape, and/or motion trajectories of the tracked objects; and/or
iii) recognizing and segmenting objects using semantic segmentation models.

### Examples of AI Models for Rgb-Based Depth Estimation/Sub-Sequence:

i) MiDaS, DPT, LeReS—for depth prediction;
ii) YOLOv8-seg, Mask R-CNN—for object segmentation;
iii) RAFT, RAFT-Stereo—for optical flow and depth; and/or
iv) newer variants using transformer-based architectures (e.g., DINOv2, SAM for segmentation).

### Example Operational Flow for Rgb-Based Depth Estimation/Sub-Sequence:

In operation, the systems and methods utilizing RGB-based depth estimation using artificial intelligence (AI) can include one or more steps including:
i) capturing RGB images in real-time (using single or multiple cameras);
ii) using depth estimation models to generate pseudo-3D maps;
iii) segmenting objects using AI-based object detectors/segmenters;
iv) tracking one or more object changes (e.g., shape, motion, etc.) frame-to-frame; and/or
v) using inferred depth maps to build pseudo-meshes for projection and/or multi-sensory outputs.

The exemplary systems and methods can be configured to produce depth maps from RGB at speeds of approximately 30 FPS. To achieve speeds of 30 FPS, the system preferably can include one or more so-called high-end GPUs (e.g., RTX 4090, Apple M2 Ultra, etc., or the like). In some examples, the RGB cameras can be configured to capture images at a lower or reduced resolution (e.g., 480p to 720p) to achieve real-time speeds. In other examples, optimization (e.g., of frame rate and fidelity) and/or model tuning can be utilized to achieve real time inferencing of depth maps, tracking and identifying objects, and/or recognizing and segmenting objects in real time.

### Example Hardware for a Real-Time Rgb AI System/Sub-Sequence:

The systems and methods utilizing RGB-based depth estimation using artificial intelligence (AI) can include, for example:
i) at least 1 high-performance GPU (NVIDIA RTX 4090 or equivalent);
ii) high frame rate, low latency RGB cameras (>60 FPS capture);
iii) optimized edge inference pipelines (TensorRT, ONNX optimizations);
iv) low-latency system bus (PCIe 4.0, NVMe drives for temporary storage); and/or
v) custom software stack for real-time prediction, caching, and fallback.

In the exemplary systems and methods utilizing RGB-based depth estimation, no specialized depth cameras are needed, thereby minimizing or reducing costs. Moreover, RGB cameras may be easier to conceal in set design, such as in a pod structure 400. Further, in this example, it may be easier to retrofit existing hardware in different locations.

The exemplary systems and methods utilizing RGB-based depth estimation using artificial intelligence (AI) can be utilized for object identification/tracking, for example, using AI and computer vision (instead of physical ToF or UWB sensors). In this example, mesh creation can be provided using dynamic photogrammetry techniques using stereo pairs or multi-view aggregation. Interaction triggers can be based, for example, on movement signatures and/or color histogram changes, not strict geometric tracking. Deformation recognition can be provided, for example, using GANs to “guess” deformations over time from RGB sequences. System synchronization can use, for example, decentralized event detection (e.g., vision-only) rather than sensor-driven state triggers.

An example system having passive optical detection will now be described.

In an example, a system for providing one or more sensory outputs (e.g., multi-sensory outputs) based on interaction with objects positioned on a surface, can include one or more imaging devices, such as one or more standard optical cameras, configured to capture images of the surface, a processing unit configured to infer depth information from the captured images using one or more machine learning models, a tracking subsystem configured to detect object interactions comprising object placement, movement, and/or deformation based on the inferred depth information, and an output subsystem configured to trigger one or more sensory outputs responsive to detected object interactions. The exemplary system operates without the use of active depth sensing technologies.

In some examples, the at least one machine learning model can be configured for monocular depth estimation. In other examples, the at least one machine learning model can be configured for stereo image depth estimation. In other examples, the tracking subsystem detects deformation of consumable objects based on time-series texture changes. In these examples, the output subsystem can be configured to trigger one or more of visual projection, audio playback, olfactory release, and/or haptic feedback. In a preferred example, the one or more imaging devices includes at least one standard optical camera configured to operate, for example, at a frame rate of at least 30 frames per second.

In other examples, the monocular depth estimation model can comprise a neural network selected from MiDaS, DPT, LeReS, or derivatives thereof. In an example, the deformation detection can be determined by comparing sequential images for changes in surface reflectivity or color spread. In examples, the olfactory output can be synchronized with one or more visual changes detected in the tracked object. In other examples, the haptic output can be triggered based on one or more acceleration vectors inferred from object movement.

In another example, a method is provided for triggering one or more sensory outputs (e.g., multi-sensory outputs) responsive to object interactions on a surface. The method comprises capturing one or more images of the surface using a standard optical camera, inferring depth information from the captured images using one or more machine learning models, detecting an interaction event based on a change in the inferred depth information, and triggering one or more sensory outputs (e.g., multi-sensory outputs) based on the detected interaction event, wherein no active depth sensors are used. The step of detecting an interaction event can include identifying deformation in an edible object placed on the surface. The one or more sensory outputs (e.g., multi-sensory outputs) can include at least one of visual projection onto the surface or the object.

### Example Subsystem Functions and Elements/Sub-Sequences

The exemplary systems and methods can provide object detection, tracking, segmentation, and/or deformation for a tabletop experience system in other ways. For example, Table 2 illustrates examples of functional features of one or more subsystems and examples of other elements that may be configured for, or capable of, providing one or more functions of the exemplary embodiments.

TABLE 2

| | System Elements and/or Features/Sub- |
|---|---|
| Subsystem Function | sequences |
| Depth Sensing/Object Mapping | AI-driven monocular or stereo RGB depth |
| | estimation without any depth cameras. |
| Object Identification | Visual fingerprinting (AI learns objects by |
| | texture, silhouette, and/or infrared |
| | reflectance), or passive optical patterns |
| | invisible to humans but detectable by machine |
| | vision. |
| Object Tracking | Optical flow (AI models like RAFT), motion |
| | vectors, color pattern analysis over time - |
| | tracking without dedicated depth info. |
| Deformation Detection | AI prediction of deformation based on |
| | progressive RGB texture changes (i.e., |
| | “melting ice cream” detection by color/shine |
| | shift). |
| Scent Activation | Time-scheduled or ambient AI sensing based |
| | on temperature/humidity/CO2 levels near the |
| | table (non-interaction-based scent timing). |
| Audio and Lighting Sync | Predictive ambient systems that run “scenes” |
| | triggered by broader human presence |
| | detection (via infrared or acoustic sensing), |
| | not object-specific. |
| Multi-Object Interaction | Broader “zone-based” detection using |
| | environmental cameras detecting only overall |
| | activity level or gesture classification. |
| Edible Objects Driving Story Events | Indirect inference from user facial |
| | expressions, hand gestures, and/or |
| | consumption prediction via body posture |
| | changes instead of tracking the object itself. |

In some examples, the exemplary systems and methods can utilize, for example, overhead infrared motion mapping and audio localization to infer user interactions without actually seeing or tracking objects precisely. In this example, the exemplary system does not include object sensors.

In still other examples, the exemplary systems and methods can be driven by (e.g., based on) detected user behavior. For example, in these examples, instead of focusing on tracking objects such as foodstuff, another exemplary embodiment can detect one or more emotional states of a user (e.g., via facial recognition, thermal cameras, and/or heart rate variability sensors, among other things) to trigger one or more sensory outputs from the one or more sensory output devices responsive to the detected one or more emotional states.

In other examples, the exemplary systems and methods can utilize pattern recognition instead of depth sensing, for example, to track “signature states” of the tabletop over time. For example, the present invention recognizes that a melting dessert may naturally spread, changing reflectance that can be passively monitored.

In still other examples, the exemplary systems and methods can utilize distributed multi-camera 2D mapping. For example, the system can include a plurality of RGB cameras capturing the table from different angles, such as a plurality of surrounding wall-mounted RGB cameras. The exemplary systems and method can be configured to fuse 2D images in one or more AI models to so-called “fake” a 3D understanding without real depth capture.

In some examples, the exemplary systems and methods can utilize one or more of ambient-based interaction detection, AI-driven table state analysis, and/or passive vision-based segmentation for multi-sensory dining tables. For example, the exemplary systems and methods can utilize one or more of passive RGB depth inference methods, texture, color or heat-based deformation detection, multi-camera 2D fusion for tabletop experience systems, human emotional state-driven interaction triggers, and/or generalized sensory trigger systems based on table state (e.g., not object-specific). The exemplary systems and methods can be configured to detect one or more interactions with one or more objects and/or table surfaces using “optical or non-optical” means and trigger one or more sensory outputs (e.g., multi-sensory outputs) from the one or more sensory output devices responsive to the detected interactions.

Other exemplary systems and methods will now be described.

### Passive Optical Detection for Tabletop Interaction Systems/Sub-Sequences

An exemplary embodiment is directed to a system for, and method of, real-time passive optical tracking and sensory triggering (e.g., multi-sensory triggering) over a surface without depth sensors. In an example, the system and method provides real-time interaction detection over a planar or non-planar surface using only standard visible light (RGB) cameras and AI-driven depth estimation models. The system infers object position, shape, and deformation without requiring active depth sensors (e.g., ToF cameras), enabling one or more sensory outputs (e.g., multi-sensory outputs) including visual, auditory, olfactory, haptic, and/or taste experiences triggered by user interaction and/or object state changes.

### Ambient State-Based Sensory Experience System/Sub-Sequences

Another exemplary embodiment is directed to a system for activating sensory experiences (e.g., multi-sensory experiences) based on environmental state estimation. In an example, the exemplary system and method monitors environmental conditions such as movement, light reflectivity, heat, humidity, or gas concentrations (CO₂, VOCs) near a target surface to infer object interactions without direct visual tracking. One or more sensory outputs (audio, visual, olfactory, haptic) can be triggered by environmental parameter changes associated with user behavior rather than discrete object sensing.

### AI-Powered Surface Texture and Deformation Detection System/Sub-Sequence

Yet another exemplary embodiment is directed to a system and method for predictive surface deformation detection and sensory triggering (e.g., multi-sensory triggering) using monocular vision. In an example, the system monitors surface texture, reflectivity, and color pattern shifts over time using single or multiple standard RGB cameras. Deformation events, such as food melting, spreading, and/or manipulation, can be inferred using AI models trained on time-series imagery, triggering synchronized sensory outputs (e.g., multi-sensory outputs) without the need for depth imaging.

### Distributed Multi-Camera 2D Fusion System for Immersive Interaction/Sub-Sequence

Another exemplary embodiment is directed to a system and method for multi-view 2D optical fusion to generate real-time 3D representations without active depth sensors. In an example, a distributed camera array system captures 2D imagery from multiple perspectives around a target area. AI-driven fusion algorithms can be utilized to generate a dynamic 3D mesh of objects on the surface, enabling real-time sensory experiences (e.g., multi-sensory experiences) based on object location and interaction states, without requiring dedicated depth sensors and/or embedded fiducials.

### Emotion-Driven Sensory Experience Activation System/Sub-Sequence

Another exemplary embodiment is directed to a system for triggering sensory experiences (e.g., multi-sensory experiences) based on user emotional state detected via optical and physiological signals. In an example, the system detects emotional states of users based on facial expression analysis, thermal imaging, posture monitoring, and/or optional physiological sensing (e.g., heart rate variability). Sensory experiences (e.g., multi-sensory experiences) such as visual projection, scent dispersal, lighting modulation, and/or audio can be triggered based on inferred emotional contexts rather than physical object interaction.

### Time-Based Multi-Sensory Output for Passive Tabletop Systems/Sub-Sequence

Another exemplary embodiment is directed to a passive sensory entertainment system (e.g., multi-sensory entertainment system) utilizing time-based content progression over table surfaces. In an example, the system and method delivers immersive, sensory (e.g., multi-sensory) experiences based on a predetermined or adaptive timecode sequence rather than direct physical interaction detection. Surface projections, lighting, scents, audio, and/or haptics can be synchronized to a show control timeline, providing a responsive experience without object tracking.

### Signature-Based Tabletop Event Detection System/Sub-Sequence

Another exemplary embodiment is directed to a system for inferring interaction events on surfaces based on signature change recognition. In an example, the system analyzes ongoing visual signatures, including for example aggregate brightness, color histograms, shape clusters, and/or heat patterns, across a surface to infer when interaction events have occurred. Events can be classified and matched against a learned database to trigger real-time sensory effects (e.g., multi-sensory effects) without individual object detection or tagging.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

1. A system for providing one or more sensory outputs based on interaction with one or more objects positioned on a surface, the system comprising:
one or more sensors configured to detect depth information of the one or more objects;
one or more sensory output devices; and
a processing unit comprising one or more processors and one or more non-transitory computer-readable storage mediums storing one or more instructions comprising one or more algorithms that when executed by the one or more processors cause the one or more processors to perform one or more steps, wherein the processing unit configured to:
detect one or more object interactions comprising placement, movement, or deformation of the one or more objects, or a combination of two or more thereof, based on the detected depth information; and
trigger one or more sensory outputs from the one or more sensory output devices responsive to the detected one or more object interactions.

2. The system of claim 1, wherein the one or more sensors comprises one or more optical sensors.

3. The system of claim 1, wherein the one or more sensors comprises one or more Time of Flight (ToF) cameras.

4. The system of claim 3, wherein the one or more sensors further comprises one or more RGB cameras.

5. The system of claim 3, wherein the one or more sensors further comprises one or more Radio-Frequency Identification (RFID) transmitters.

6. The system of claim 3, wherein the one or more sensors further comprises one or more Ultra-wideband (UWB) transmitters.

7. The system of claim 1, wherein an object of the one or more objects comprises one or more fiduciary markers visible to a sensor of the one or more sensors.

8. The system of claim 1, wherein the one or more sensors comprises one or more LIDAR (Light Detection and Ranging) sensors.

9. The system of claim 1, wherein the one or more sensors comprises one or more mmWave (Millimeter-wave Radar) sensors.

10. The system of claim 1, wherein the one or more sensors are configured for active depth sensing.

11. The system of claim 3, wherein the one or more Time of Flight (ToF) cameras includes at least a first Time of Flight (ToF) camera and a second Time of Flight (ToF) camera, and
wherein the first Time of Flight (ToF) camera and the second Time of Flight (ToF) camera are configured to capture overlapping fields of view.

12. The system of claim 11, wherein each of the first Time of Flight (ToF) camera and the second Time of Flight (ToF) camera is arranged at a predetermined downfacing angle to the surface.

13. The system of claim 11, wherein the first Time of Flight (ToF) camera and the second Time of Flight (ToF) camera are configured to capture images at a predetermined time offset from each other.

14. The system of claim 1, wherein the one or more sensory output devices comprises one or more video projectors.

15. The system of claim 14, wherein the one or more video projectors includes at least a first video projector and a second video projector, and
wherein the first video projector and the second video projector are configured to project overlapping fields of projection.

16. The system of claim 15, wherein each of the first video projector and the second video projector is arranged at a predetermined downfacing angle to the surface.

17. The system of claim 14, wherein the one or more sensory output devices comprises one or more audio devices, olfactory devices, transducers, or LED lighting systems, or a combination of two or more thereof.

18. A system for providing one or more sensory outputs based on interaction with one or more objects positioned on a surface, the system comprising:
detecting means for detecting depth information of the one or more objects;
one or more sensory output devices; and
processing means for detecting one or more object interactions comprising placement, movement, or deformation of the one or more objects, or a combination of two or more thereof, based on the detected depth information and triggering one or more sensory outputs from the one or more sensory output devices responsive to the detected one or more object interactions.

19. A method of providing one or more sensory outputs based on interaction with one or more objects positioned on a surface, the method comprising:
detecting, using one or more sensors, depth information of the one or more objects;
detecting, using a processing unit comprising one or more processors and one or more non-transitory computer-readable storage mediums storing one or more instructions comprising one or more algorithms that when executed by the one or more processors cause the one or more processors to perform one or more steps, one or more object interactions comprising placement, movement, or deformation of the one or more objects, or a combination of two or more thereof, based on the detected depth information; and
triggering, using a processing unit, one or more sensory outputs from one or more sensory output devices responsive to the detected one or more object interactions.

20. The method of claim 19, wherein the one or more sensors comprises one or more optical sensors.

21. The method of claim 19, wherein the one or more sensors comprises one or more Time of Flight (ToF) cameras.

22. The method of claim 21, wherein the one or more sensors further comprises one or more RGB cameras.

23. The method of claim 22, wherein the one or more sensors further comprises one or more Radio-Frequency Identification (RFID) transmitters, Ultra-wideband (UWB) transmitters, LIDAR (Light Detection and Ranging) sensors, mmWave (Millimeter-wave Radar) sensors, or a combination of two or more thereof.

24. The method of claim 21, wherein the one or more Time of Flight (ToF) cameras includes at least two Time of Flight (ToF) cameras configured to capture overlapping fields of view and arranged at a predetermined downfacing angle to the surface.

25. The method of claim 24, wherein the at least two Time of Flight (ToF) cameras are configured to capture images at a predetermined time offset from each other.

26. The method of claim 19, wherein the one or more sensory output devices comprises one or more video projectors.

27. The method of claim 19, wherein the one or more sensory output devices comprises one or more video projectors including at least a first video projector and a second video projector,
wherein the first video projector and the second video projector are configured to project overlapping fields of projection, and
wherein each of the first video projector and the second video projector is arranged at a predetermined downfacing angle to the surface.

28. The method of claim 27, wherein the one or more sensory output devices comprises one or more audio devices, olfactory devices, transducers, or LED lighting systems, or a combination of two or more thereof.
